(19) United States
(12) Patent Application Publication
(10) Pub. No.: US 2015/0220343 A1
(43) Pub. Date: Aug. 6, 2015

(54) Computer Processor Employing Phases of Operations Contained in Wide Instructions

(71) Applicant: Mill Computing, Inc., Palo Alto, CA (US)

(72) Inventors: Roger Rawson Godard, East Palo Alto, CA (US); Arthur David Kahlich, Sunnyvale, CA (US); David Arthur Yost, Los Altos, CA (US); Sebastien Paul Maurice Mirolo, San Francisco, CA (US)

(73) Assignee: MILL COMPUTING, INC., Palo Alto, CA (US)

(21) Appl. No.: 14/667,404

(22) Filed: Mar. 24, 2015

Related U.S. Application Data
(63) Continuation-in-part of application No. 14/622,154, filed on Feb. 13, 2015.
(60) Provisional application No. 61/936,121, filed on Feb. 5, 2014.

(51) Int. Cl. G06F 9/30

(52) U.S. Cl. CPC G06F 9/30181; G06F 9/3001; G06F 9/30058

(57) ABSTRACT

A computer processor employs an instruction processing pipeline that processes a sequence of wide instructions each having an encoding that represents a plurality of different operations. The plurality of different operations of the given wide instruction are logically organized into a number of phases having a predefined ordering such that at least one operation of the given wide instruction produces data that is consumed by at least one other operation of the given wide instruction. In certain circumstances where stalling is absent, the plurality of different operations of the phases of the given wide instruction can be issued for execution by the instruction processing pipeline over a plurality of consecutive machine cycles.

### CROSS-REFERENCE TO RELATED APPLICATIONS

The present disclosure claims priority from U.S. Prov. Appl. No. 61/936,121, filed on Feb. 5, 2014 and is a continuation-in-part of U.S. application Ser. No. 14/622,154, filed on Feb. 13, 2015, herein incorporated by reference in their entireties.

### BACKGROUND

1. Field

The present disclosure relates to computer processors (also commonly referred to as CPUs).

2. State of the Art

Modern computer architectures are primarily driven by the physical constraints of the hardware at the gate level. And all computer architectures in common use today are actually historical designs conceived thirty to forty years ago. This has resulted in the logical data flow grouping at the instruction level to be more or less ad hoc, wherever the bits and wires of the hardware fit. The instruction streams are flat and the data and control flows emerge from them are ad hoc, too. Thus, the hardware has no real structure to work with and expect and be prepared for. This is one reason that modern out-of-order computer architectures exist. They look ahead in the instruction flow and try to bring the flat opaque instructions into a better ordered data and control flow for the available hardware. However, such out-of-order architectures require complex circuits that take up large areas of the integrated circuit and consume large amounts of power.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

Illustrative embodiments of the present disclosure are directed to a computer processor having an instruction processing pipeline that processes a sequence of wide instructions. Each given wide instruction has an encoding that represents a plurality of different operations. The plurality of different operations of the given wide instruction are logically organized into a number of phases having a predefined ordering such that at least one operation of the given wide instruction produces data that is consumed by at least one other operation of the given wide instruction.

In one embodiment, in certain circumstances where stalling is absent, the plurality of different operations of the phases of the given wide instruction are issued for execution by the instruction processing pipeline over a plurality of consecutive machine cycles. For example, the plurality of consecutive machine cycles can be three consecutive machine cycles.

In another embodiment, the phases of operations of the given wide instruction can include at least a first phase that includes at least one operation that is a pure data source, a second phase that includes at least one operation that is both a data sink and a data source, and a third phase that includes at least one operation that is a pure data sink. The least one operation of the first phase can precede the at least one operation of the second phase in the predefined order and the least one operation of the second phase can precede the at least one operation of the third phase in the predefined order. The at least one operation of the first phase can include at least one operation that defines a constant value or immediate operand value. The at least one operation of the second phase can include a plurality of data manipulation operations selected from the group including integer operations, arithmetic operations and floating point operations. The at least one operation of the third phase can include at least one operation selected from the group including a branch operation and a store operation that writes operand data values to cache memory. The at least one operation of the second phase can also include a load operation that reads operand data values from cache memory. The at least one operation of the first phase can be issued for execution before issuance of the at least one operation of the second phase, and the at least one operation of the second phase can be issued for execution before issuance of the at least one operation of the third phase. In certain circumstances where stalling is absent, the plurality of different operations of the phases of the given wide instruction are issued for execution by the instruction processing pipeline over three consecutive machine cycles, wherein the at least one operation of the first phase is issued for execution in the first machine cycle of the three consecutive machine cycles, wherein the least one operation of the second phase is issued for execution in the second machine cycle of the three consecutive machine cycles, and wherein the at least one operation of the third phase is issued for execution in the third machine cycle of the three consecutive machine cycles.

In still another embodiment, the phases of operations of the given wide instruction can include a fourth phase that includes at least one CALL operation that transfers control to a target code segment. The at least one operation of the fourth phase can follow the at least one operation of the second phase in the data flow. The at least one operation of the fourth phase can precede the at least one operation of the third phase in the data flow. The fourth phase can include a plurality of conditional CALL operations whose precedence in control flow during execution is dictated dynamically by evaluation of a predefined rule. The predefined rule can be based on the order of the plurality of conditional CALL operations in the wide instruction. The at least one operation of the third phase can include at least one RETURN operation to a Caller code segment.

In yet another embodiment, the phases of operations of the given wide instruction can include at least a fifth phase that includes at least one operation that selects one of two source operand values based on a conditional predicate. The at least one operation of the fifth phase can follow the at least one operation of the second phase and fourth phase (if used) in the data flow, and wherein the at least one operation of the fifth phase can precede the at least one operation of the third phase in the data flow.

Each given wide instruction can include a plurality of encoding slots that contain the different operations of the phases of the given wide instruction. In one embodiment, the instruction processing pipeline can include a plurality of functional unit slots that correspond to the plurality of encodings slots and include functional units that are configurable to execute the phases of operations that are contained in the corresponding encodings slots. The plurality of functional unit slots can include at least one functional unit slot with a plurality of functional units that share a set of input data paths. The plurality of functional unit slots can include at least one functional unit slot with a plurality of functional units that share a set of dedicated result registers. The plurality of functional unit slots can include at least one functional unit slot with at least one ganged functional unit having at least one input data path leading from a neighboring functional unit slot. The at least one input data path leading from the neighboring functional unit slot can be used to carry source operand data values to the ganged functional unit during the processing of a special operation encoded as part of a wide instruction. The at least one input data path leading from the neighboring functional unit slot can also be used to carry conditional codes or other state information produced by the neighboring functional unit slot to the ganged functional unit during the processing of a special operation encoded as part of a wide instruction.

In still another embodiment, at least one operation of the given wide instruction includes multiple actions as part of its overall effect and these multiple actions occur in different phases of the given wide instruction.

In yet another embodiment, at least one operation of the given wide instruction represents a deferred conditional branch operation for processing within the phases of the given wide instruction.

### BRIEF DESCRIPTION OF THE DRAWINGS

FIG. 1 is a schematic block diagram of a computer processing system according to an embodiment of the present disclosure.

FIG. 2 is a schematic diagram of exemplary pipeline of processing stages that can be embodiment by the computer processor of FIG. 1.

FIG. 3 is schematic illustration of components that can be part of the execution/retire logic of the computer processor of FIG. 1 according to an embodiment of the present disclosure.

FIG. 4 is schematic illustration of components that can be part of the execution/retire logic and memory hierarchy of the computer processor of FIG. 1 according to an embodiment of the present disclosure.

FIG. 5A is a table illustrating exemplary phases of operations for a wide instruction that can be supported by the execution/retire logic of the computer processor of FIG. 1 according to an embodiment of the present disclosure.

FIG. 5B is a diagram illustrating an exemplary predefined ordering (dataflow) of the phases of operations of a wide instruction depicted in the table of FIG. 5A.

FIG. 6A is a chart that illustrates exemplary pipeline stages of the execution/retire logic of the computer processor of FIG. 1 that execute certain phases of operations set forth in the table of FIG. 5 according to an embodiment of the present disclosure.

FIG. 6B is a diagram illustrating an exemplary predefined ordering (dataflow) for pipelined execution of the phases of operations for three wide instructions carried out as part of the pipeline stages of FIG. 6A.

FIG. 7 is a schematic illustration of a functional unit slot of the execution/retire logic of the computer processor of FIG. 1 according to an embodiment of the present disclosure.

FIG. 8 is a schematic illustration of two neighboring functional unit slots of the execution/retire logic of the computer processor of FIG. 1, wherein the neighboring functional unit slots employ a ganged multiplier function unit according to an embodiment of the present disclosure.

FIG. 9 is a schematic illustration of multiple branch functional units and a circular buffer that are part of the execution/retire logic of the computer processor of FIG. 1.

FIG. 10 is a pictorial schematic illustration of the circular buffer of FIG. 9 and associated cursor register.

FIG. 11 is a flowchart illustrating the processing of a deferred conditional branch operation that encodes a statically-known schedule latency by one of the branch functional units of FIG. 9 in accordance with a First Branch Taken Wins (FBT) rule.

FIG. 12 is a flowchart illustrating the processing of the execution/retire logic in retiring target addresses of deferred conditional branch operations executed by the branch functional units of FIG. 9.

FIG. 13 is a flowchart illustrating the processing of a deferred conditional branch operation that encodes a statically-known schedule latency by one of the branch functional units of FIG. 9 in accordance with a Last Branch Taken Wins (LBT) rule.

FIG. 14 is a schematic illustration of multiple branch functional units, a pickup functional unit, a circular buffer and a second buffer for pickup correspondence that are part of the execution/retire logic of the computer processor of FIG. 1.

FIG. 15 is a flowchart illustrating the processing of a deferred conditional branch operation that encodes a statically unknown schedule latency by one of the branch functional units of FIG. 9.

FIG. 16 is a flowchart illustrating the processing of a PICKUP operation that dictates the schedule latency of a corresponding conditional branch operation by the pickup functional unit of FIG. 15 in accordance with a Last Branch Taken Wins (LBT) rule.

### DETAILED DESCRIPTION OF THE PREFERRED EMBODIMENTS

Illustrative embodiments of the disclosed subject matter of the application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

As used herein, the term “operation” is a unit of execution, such as an individual ADD, LOAD, STORE or BRANCH operation.

The term “instruction” is a unit of logical encoding including zero or more operations.

The term “wide instruction” is an instruction that contains multiple operations that are issued for execution over a pre-defined number of consecutive cycles according to the semantics of the instruction.

The term “dataflow” is logical program model characterizing the execution of a sequence of operations; the logical program model describes the order of operations and the interaction between the operations arising from the flow of data between operations. In a dataflow, certain operations can consume the results of prior operations, and the first operation in the sequence can function as pure data source for subsequent operations in the sequence.

The term “hierarchical memory system” is a computer memory system storing instructions and operand data for access by a processor in executing a program where the memory is organized in a hierarchical arrangement of levels of memory with increasing access latency from the top level of memory closest to the processor to the bottom level of memory furthest away from the processor.

The term “cache line” or “cache block” is a unit of memory that is accessed by a computer processor. The cache line includes a number of bytes (typically 64 to 128 bytes).

The term “functional unit” (which is also commonly called an execution unit) is a part of a CPU (CPU Core) that performs the operations and calculations called for by the sequence of instructions of a computer program. It may have its own internal control sequencer, some registers, and other internal circuitry. It is common for modern CPUs (CPU Cores) to have multiple parallel execution units, referred to as scalar or superscalar design, including functional units for integer and logic operations, functional units for address arithmetic (such as calculating an effective address), functional units for floating point operations, functional units for SIMD operations, and functional units for control flow operations (such as conditional branch operations).

The “issue cycle” of an operation is the machine cycle when the operation begins execution.

The “retire cycle” of an operation follows the issue cycle and is the machine cycle when the execution of the operation has completed and its results are available, and/or any machine consequences must become visible. In the retire cycle, the results can be written back to operand storage or otherwise made available to functional units of the CPU or core.

The “schedule latency” of an operation is the number of machine cycles between the issue cycle and the retire cycle of the operation.

In accordance with the present disclosure, a sequence of wide instructions is stored in a hierarchical memory system 101 and processed by a CPU (or Core) 102 as shown in the exemplary embodiment of FIG. 1. The memory system 101 can include the following components arranged in order of decreasing speed of access:
a form of fast operand storage, such as a belt or register file;
one or more levels of cache memory, where the one or more levels of the cache memory can be integrated with the processor (on-chip cache) or separate from the processor (off-chip cache);
main memory (or physical memory), which is typically implemented by DRAM memory and/or NVRAM memory and/or ROM memory; and
on-line mass storage (typically implemented by one or more hard disk drives).

The main memory of the memory system can take several hundred machine cycles to access. The cache memory, which is much smaller and more expensive but with faster access as compared to the main memory, is used to keep copies of data that resides in the main memory. If a reference finds the desired data in the cache (a cache hit) it can access it in a few machine cycles instead of several hundred when it doesn't (a cache miss). Because a program typically has nothing else to do while waiting to access data in memory, using a cache and making sure that desired data is copied into the cache can provide significant improvements in performance.

The CPU (or Core) 102 also includes a number of instruction processing stages including at least one instruction fetch unit (one shown as 103), at least one instruction buffer or queue (one shown as 105), at least one decode stage (one shown as 107) and execution/retire logic 109 that are arranged in a pipeline manner as shown. The CPU (or Core) 102 can also include at least one program counter (one shown as 111), at least one L1 instruction cache (one shown as 113), and an L1 data cache 115.

The L1 instruction cache 113 and the L1 data cache 115 are logically part of the hierarchy of the memory system 101. The L1 instruction cache 113 is a cache memory that stores copies of wide instruction portions stored in the memory system 101 in order to reduce the latency (i.e., the average time) for accessing the wide instruction portions stored in the memory system 101. In order to reduce such latency, the L1 instruction cache 113 can take advantage of two types of memory localities, including temporal locality (meaning that the same wide instruction will often be accessed again soon) and spatial locality (meaning that the next memory access for the wide instructions is often very close to the last memory access or recent memory accesses for the wide instructions). The L1 instruction cache 113 can be organized as a set-associative cache structure, a fully associative cache structure, or a direct mapped cache structure as is well known in the art. Similarly, the L1 data cache 115 is a cache memory that stores copies of operands stored in the memory system 101 in order to reduce the latency (i.e., the average time) for accessing the operands stored in the memory system 101. In order to reduce such latency, the L1 data cache 115 can take advantage of two types of memory localities, including temporal locality (meaning that the same operand will often be accessed again soon) and spatial locality (meaning that the next memory access for operands is often very close to the last memory access or recent memory accesses for operands). The L1 data cache 115 can be organized as a set-associative cache structure, a fully associative cache structure, or a direct mapped cache structure as is well known in the art. The hierarchy of the memory system 201 can also include additional levels of cache memory, such as a level 2 and level 3 caches, as well as system memory. One or more of these additional levels of the cache memory can be integrated with the CPU 202 as is well known. The details of the organization of the memory hierarchy are not particularly relevant to the present disclosure and thus are omitted from the figures of the present disclosure for sake of simplicity.

The program counter 111 stores the memory address for a particular wide instruction and thus indicates where the instruction processing stages are in processing the sequence of instructions. The memory address stored in the program counter 111 can be logically partitioned into a number of high-order bits representing a cache line address and a number of low-order bits representing a byte offset within the cache line for the current wide instruction. The memory address stored in the program counter 111 can be used to control the fetching one or more cache lines by the instruction fetch unit 103 where such cache line(s) contain part (or all) of the wide instruction that is desired to be fetched. Specifically, the memory address of such cache line(s) can be derived from a predicted (or resolved) target address of a control-flow operation (BRANCH or CALL operation), the saved address in the case of a RETURN operation, or the sum of memory address of the previous instruction and the length of previous instruction.

The instruction fetch unit 103, when activated, sends a request to the L1 instruction cache 113 to fetch a cache line from the L1 instruction cache 113 at a specified cache line address ($ Cache Line). This cache line address can be derived from the high-order bits of the program counter 111. The L1 instruction cache 113 services this request (possibly accessing higher levels of the memory system 101 if missed in the L1 instruction cache 113), and supplies the requested cache line to the instruction fetch unit 103. The instruction fetch unit 103 passes the cache line returned from the L1 instruction cache 113 to the instruction buffer 105 for storage therein.

The decode stage 107 is configured to decode one or more wide instructions stored in the instruction buffer 105. Such decoding generally involves parsing and decoding the bits of the wide instruction to determine the type of operation(s) encoded by the wide instruction and generate control signals required for execution of the operation(s) encoded by the wide instruction by the execution/retire logic 109.

The execution/retire logic 109 utilizes the results of the decode stage 107 to execute the operation(s) encoded by the wide instructions. The execution/retire logic 109 can send a load request to the L1 data cache 115 to fetch data from the L1 data cache 115 at a specified memory address. The L1 data cache 115 services this load request (possibly accessing higher levels of the memory system 101 if missed in the L1 data cache 115), and supplies the requested data to the execution/retire logic 109. The execution/retire logic 109 can also send a store request to the L1 data cache 115 to store data into the memory system at a specified address. The L1 data cache 115 services this store request by storing such data at the specified address (which possibly involves overwriting data stored by the data cache).

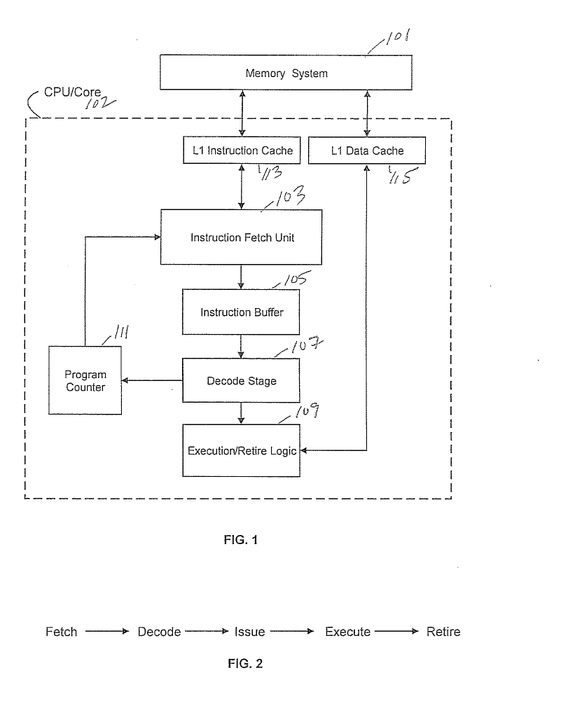

The instruction processing stages of the CPU (or Core) 102 can achieve high performance by processing each wide instruction and its associated operation(s) as a sequence of stages each being executable in parallel with the other stages. Such a technique is called “pipelining.” A wide instruction and its associated operation(s) can be processed in five exemplary stages, namely, fetch, decode, issue, execute and retire as shown in FIG. 2. Note that other stage organizations may be used as is well known.

In the fetch stage, the instruction fetch unit 103 sends a request to the L1 instruction cache 113 to fetch a cache line from the L1 instruction cache 113. The instruction fetch unit 103 passes the cache line returned from the L1 instruction cache 113 to the instruction buffer 105 for storage therein.

The decode stage 107 decodes one or more wide instructions stored in the instruction buffer 107. Such decoding generally involves parsing and decoding the bits of the wide instruction to determine the type of operation(s) encoded by the wide instruction and generating control signals required for execution of the operation(s) encoded by the wide instruction by the execution/retire logic 109.

In the issue stage, one or more operations as decoded by the decode stage are issued to the execution logic 109 and begin execution.

In the execute stage, issued operations are executed by the functional units of the execution/retire logic 109 of the CPU/Core 102.

In the retire stage, the results of one or more operations produced by the execution/retire logic 109 are stored by the CPU/Core 102 as transient result operands for use by one or more other operations in subsequent issue/execute cycles.

The execution/retire logic 109 includes a number of functional units (FUs) which perform primitive steps such as adding two numbers, moving data from the CPU proper to and from locations outside the CPU such as the memory hierarchy, and holding operands for later use, all as are well known in the art. Also within the execution/retire logic 109 is a data crossbar network connected to the FUs so that data produced by a producer (source) FU can be passed to a consumer (sink) FU for further storage or operations. The FUs and the data crossbar network of the execution/retire logic 109 are controlled by the executing program to accomplish the program aims.

During the execution of an operation by the execution logic 109 in the execution stage, the functional units can access and/or consume transient operands that have been stored by the retire stage of the CPU/Core 102. Note that some operations take longer to finish execution than others. The duration of execution, in machine cycles, is the execution latency of an operation. Thus, the retire stage of an operation can be latency cycles after the issue stage of the operation. Note that operations that have issued but not yet completed execution and retired are “in-flight.” Occasionally, the CPU/Core 102 can stall for a few machine cycles. Nothing issues or retires during a stall and in-flight operations remain in-flight.

For most operations (such as an ADD operation), the execution latency is fixed in terms of machine cycles. For some operations, the execution latency may vary from execution to execution depending on details of the argument operands or the state of the machine.

The issue cycle of an operation (the machine cycle when the operation begins execution) precedes the retire cycle (the machine cycle when the execution of the operation has completed and its results are available, and/or any machine consequences must become visible). In the retire cycle, the results can be written back to operand storage (e.g., a register file or a belt (which is described in U.S. patent application Ser. No. 14/312,159, on Jun. 23, 2014, commonly assigned to the assignee of the present application and herein incorporated by reference above in its entirety)) or otherwise made available to functional units of the processor. For operations of fixed execution latency, the results of the operation will be available naturally during the retire cycle, a number of machine cycles later corresponding to the execution latency of the operation, and consumers of those results can then be issued. This makes it easy to schedule operations with fixed execution latency. This scheduling strategy is called static scheduling with exposed pipeline, and is common in stream and signal processors.

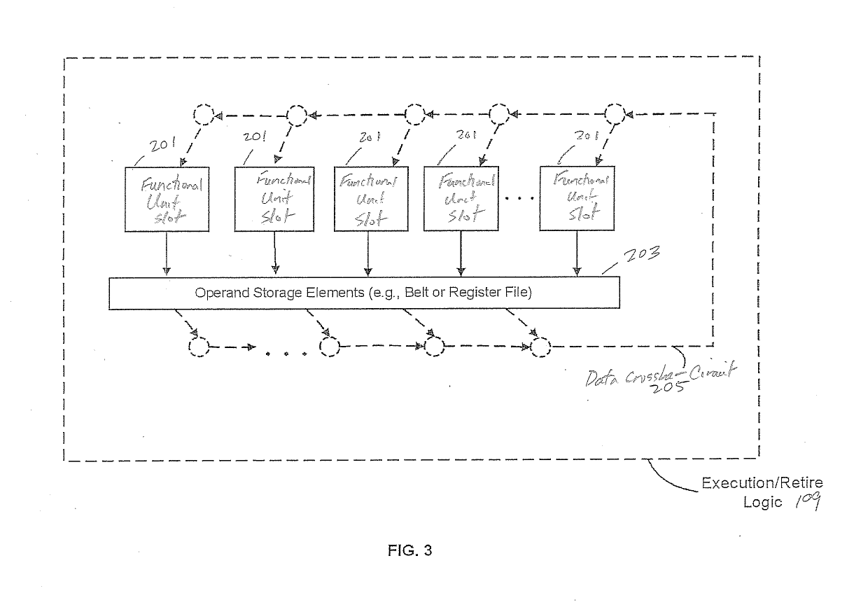

FIG. 3 is a schematic diagram illustrating the architecture of an embodiment of the execution/retire logic 109 of the CPU/Core 102 of FIG. 1 according to the present disclosure, including a number of functional unit slots 201. The execution/retire logic 109 also includes a set of operand storage elements 203 that are operably coupled to the functional unit slots 201 of the execution/retire logic 109 and configured to store transient operands that are produced and referenced by the functional unit slots of the execution/retire logic 109. A data crossbar network 205 provides a physical data path from the operand storage elements 203 to the functional unit slots that can possibly consume the operand stored in the operand storage elements. The data crossbar network 205 can also provide the functionality of a bypass routing circuit (directly from a producer functional unit to a consumer function unit).

The functional unit slots and the data crossbar network of the execution logic 109 must be controlled by the executing program to accomplish the program aims. Rather than exert this control directly at a per-transistor or per circuit level, which would require much too voluminous control information in the program to be practical, the control is abstracted into a logical program model, an idealized logical representation of the CPU that the control provided by the program manipulates. As is well known, there are several possible such program models, including general-register machines, accumulator machines, and stack machines previously mentioned.

Because the logical program model is a logical representation of the CPU, it is not required that the CPU hardware actually be implemented in a form that closely matches the logical program model. So long as the hardware is able to present to the program the illusion that the CPU acts like the logical program model, it may internally be implemented in any way desired. This degree of freedom in hardware design is heavily exploited in the well-known art, and it is very common for the actual working of a hardware CPU to have little resemblance to the logical program model it represents.

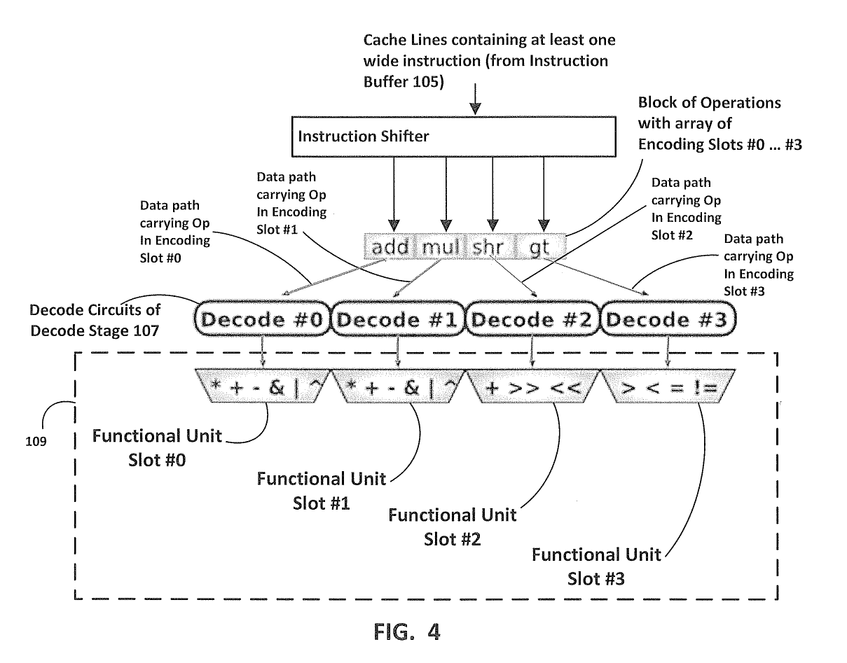

FIG. 4 is a schematic diagram illustrating the architecture of an illustrative embodiment of the CPU/Core 102 of FIG. 1 according to the present disclosure. The CPU/Core 102 employs wide instructions where each wide instruction encodes a group of operations in a number of variable-length blocks. Within these variable length blocks are a number of operations arranged in arrays. Each position in these arrays is called an encoding slot which includes binary data that represents an operation. Consequently, the blocks have their own specialized binary operation format. The wide instructions of the instruction stream are contained in cache lines stored in the instruction buffer 105 as a result of the fetch stage. Such cache lines are processed by an instruction shifter that operates to shift one or more cache lines such that the current wide instruction is aligned in the lower order bits of the instruction shifter. This alignment operation can be performed as part of the instruction fetch process and thus conceptually can be part of the instruction buffer 105. The instruction shifter also operates to isolate one or more blocks of the wide instruction and supplies the operations contained in the encoding slots of the respective isolated blocks to corresponding decode circuits via data paths therebetween. Each encoding slot corresponds directly to a dedicated decode circuit of the decode stage 107 as well as to a functional unit slot (described below) of the execution retire logic 109. The dedicated decode circuit parses and decodes the operation contained in the corresponding encoding slot, which can involve determining the type of operation encoded by the bits of the encoding slot and generating control signals required for execution of the operation by the corresponding functional unit slot. The results of the respective decode circuits are used to send requests to the corresponding functional unit slots (or in some cases like the pick operation to the data crossbar circuit) of the execution/retire logic 109 to perform the decoded operation.

Note that FIG. 4 illustrates an exemplary arrangement that employs four decode circuits and four functional unit slots for decoding and issue and execution with respect to the operations contained in four encoding slots for one block of the wide instruction. In the case that the wide instruction includes two other blocks of operations (for a total of three blocks of operations), two additional sets of decode circuits and functional unit slots can be provided corresponding to these two other blocks of operations for the decoding and issue and execution with respect to the operations contained in the encoding slots for these two other blocks of the wide instruction.

Furthermore, the encoding slots of the blocks of the wide instruction as well as the corresponding decode circuits of the decode stage 107 and the functional unit slots of the execution/retire logic 109 are generally arranged according to a pre-defined grouping of operations called phases. In this manner, there is a pre-defined mapping or set of constraints that relate the encoding slots of the blocks of the wide instruction as well as the corresponding decode circuits of the decode stage 107 and the functional unit slots of the execution/retire logic 109 to the phases of operations. In this configuration, the functional unit slots of the execution/retire logic 109 are populated with functional units that are capable of executing the operations that belong to the operations of the particular phase that is mapped to (associated with) the respective functional unit slots. This mapping can be used by a compiler and/or other software tool to arrange the operations within a sequence of wide instructions such that they represent the desired program of operations when executed by the CPU. This is a form of static scheduling of instructions.

Note that the phases of operations relate to issuance of the operations, or when some action of the issue or execution process takes place. Each operation defines what it does, if anything, in each phase. In this context, an operation can do a number of functions in a given phase, including the evaluation of one or more input arguments, the performance of computation, and the appearance of side effects such as the transfer of control to a different instruction.

Also note that the phases of the operations is only somewhat related to the organization of operations in the semantic encoding of the wide instruction. Because some issue/execution actions can take place before others, and all must be under control of a decoded operation, it can be convenient that early phase operations are decoded early from the wide instruction. However, it is not required that encoding format of the wide instruction determine the phases of operation. Rather, the phases of operations can be set by the operation definition. In this case, the phases of operations, and the decode sequence of the encoding slots of a wide instruction, then constrain which operations may be encoded in which encoding slot. Sometimes the constraint is tight and a particular operation can only be encoded in a particular encoding slot of the wide instruction or the timing won't work. Other times the constraint is looser, and a particular operation may be encoded in two or more different encoding slots of the wide instruction. In this case other factors (such as format similarity to other instruction encodings) will suggest a choice of encoding slot for the particular operation.

In order to exploit instruction level parallelism in the wide instructions, the phases of operations of a given wide instruction are issued for execution in consecutive machine cycles. Furthermore, there is an ordering of the phases with respect to the issuance of operations over the consecutive machine cycles. And each given phase of operations can access the results of operations for the phases prior to the given phase (where these operations retire prior to the issuance of the given phase of operations). Thus, the phases of operations in the given wide instruction execute in sequence as a dataflow. For example, consider an example where the encoding slots of the blocks of a given wide instruction as well as the corresponding decode circuits of the decode stage 107 and the functional unit slots of the execution/retire logic 109 are arranged according a pre-defined group of three phases labeled “Phase A,” “Phase B” and “Phase C.” The “Phase A” operations of the given wide instruction are issued for execution in the first machine cycle with respect to the issuance of operations of all phases of the given wide instruction. And the “Phase A” operations can access the results of operations for the phases prior to this Phase A (for the case where these operations retire prior to the issuance of the “Phase A” operations). The “Phase B” operations of the given wide instruction are issued for execution in the second machine cycle with respect to the issuance of operations of all phases of the given wide instruction. And the “Phase B” operations can access the results of operations for the phases prior to this Phase B (for the case where these operations retire prior to the issuance of the “Phase B” operations). Finally, the “Phase C” operations of the given wide instruction are issued for execution in the third machine cycle with respect to the issuance of operations of all phases of the given wide instruction. And the “Phase C” operations can access the results of operations for the phases prior to this Phase C (for the case where these operations retire prior to the issuance of the “Phase C” operations). In this example, the phases of operations in the given wide instruction execute in the sequence A then B then C as a dataflow.

In defining the grouping of the phases, the particular phase that a particular operation is assigned to can depend on how that particular operation produces and/or consumes values. Furthermore, the issue order of the phases can be determined by data flow. Specifically, operations that produce operand data (referred to herein as “producers” or “data sources”) can be executed before operations that consume operand data (referred to herein as “consumers” or “data sinks”) in order to maximize instruction level parallelism. An operation that is a pure data source is one that produces operand data and does not consume operand data. An operation that is a pure data sink is one that consumes operand data and does not produce operand data. The phasing of operations can almost be directly expressed in the encoding of the wide instruction, and the order of the decoding operations can map to the ordering of the phases of operations in the wide instruction.

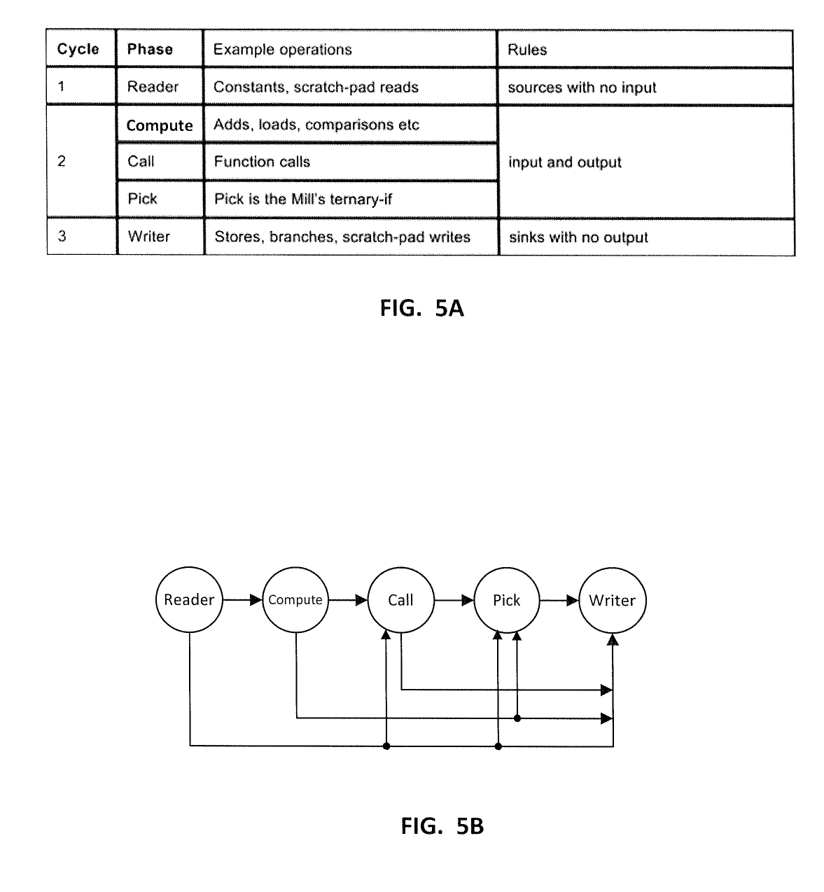

In another example, consider an embodiment where the encoding slots of the blocks of the wide instructions as well as the corresponding decode circuits of the decode stage 107 and functional unit slots of the execution/retire logic 109 are arranged according a pre-defined group of five phases (“Reader Phase” operations, “Compute Phase” operations, “Call Phase Operations, “Pick Phase” operations, and “Writer Phase” operations) as specified in FIG. 5A. In this example, the phases of operations in a given wide instruction execute in the sequence “Reader Phase” operations then “Compute Phase” Operations then “Call Phase” operands then “Pick Phase Operations” then “Writer Phase” Operations as a dataflow as represented in FIG. 5B. Note that the directed edges between the phases represent the possible flow of data between two phases. Such flow is optional as it is possible that some (or in the extreme case all) of the operations will be pure data sources in the dataflow.

The operations of the “Reader Phase” can produce operand values for later consumption but have no dynamic source operands, and thus are pure data sources. The arguments for the “Reader Phase” operations can be limited to static values that are defined directly in the encoding of the respective “Reader Phase” operation and thus do not require access to the operand storage elements (e.g., belt storage elements or register file) that store dynamic source operand values. The “Reader Phase” operations can also include operations that access constant immediate values or internal hardware state stored in fast local registers. The operations of the “Reader Phase” can be issued in the first machine cycle with respect to the issuance of operations of all phases of the given wide instruction. The “Reader Phase” operations can issue and execute in one machine cycle such that they can be consumed by the operations in the subsequent phases (“Compute Phase,” “Call Phase” or Pick Phase” operations) of the same wide instruction in the next machine cycle (or subsequent machine cycles, if available). The operations of the “Reader Phase” can have a hardcoded parameter that identifies the source operand, and this parameter can actually define the whole operation while avoiding the use of an opcode.

The operations of the “Compute Phase” can perform all major data manipulation operations, including arithmetic and logic operations, floating point operations, and load operations. The “Compute Phase” operations can have dynamic source operands and can produce result operand values for later consumption. The operations of the “Compute Phase” can be issued in the second machine cycle with respect to the issuance of operations of all phases of the given wide instruction. The operations of the “Compute Phase” can access the results of operations for phases prior to this phase, including the “Reader Phase” of the same wide instruction (for the case where these operations retire prior to the issuance of the “Compute Phase” operations). The execution latency of the “Compute Phase” operations can be defined and fixed for each such operation. This is a form of static scheduling, but can vary significantly. The execution latency of certain “Compute Phase” operations can be unknown and variable based upon program behavior (such as load operations that read data from cache memory with variable latency). Retire stations can be used to hold results from these operations and then retire them for access by other operations as needed. The operations of the “Compute Phase” can include all major data manipulation operations with two source operands and have an opcode whose size is dependent on the population of “Compute Phase” operations for the encoding slots of the given wide instruction. Thus, the opcode size for the “Compute Phase” operations can vary over the encoding slots of the given wide instructions that contain “Compute Phase” operations. The source operands can be specified by an identifier (such as belt position or register number), or can be specified by an immediate value (which can be encoded as the second argument of the “Compute Phase” operation).

The operations of the “Call Phase” can involve flow control stemming from one or more CALL operations that perform a function or subroutine call to a target code segment. The operations of the “Call Phase” can be issued in the second machine cycle with respect to the issuance of operations of all phases of the given wide instruction. The “Call Phase” operations can issue after issuance of the “Compute Phase” operations for the wide instruction. The operations of the “Call Phase” can access the results of operations for phases prior to this phase, including the “Reader Phase” and “Compute Phase” of the same wide instruction (for the case where these operations retire prior to the issuance of the “Call Phase” operations). From the perspective of the program code segment that includes a CALL operation (the Caller), the flow control of the CALL operation does not require any cycles, and in a sense is an extension of the “Compute Phase” operations. However, such operations do need cycles to execute. Note that the CALL operation does not actually produce any new values. Instead, existing values are renamed and rerouted such that they are arguments for the target code segment of the CALL operation. In one example, the CALL operation itself can execute in the second machine cycle and it operates to store the data flow of the Caller and then begins execution of the instruction(s) of the target code segment. In one embodiment, the data flow of the Caller (typically referred to as the current function frame), which can include the contents of the operand storage elements (such as a belt or register file and possibly Scratchpad memory of the Caller) can be saved by a spiller unit as described in U.S. patent application Ser. No. 14/311,988, on Jun. 23, 2014, commonly assigned to the assignee of the present application and herein incorporated by reference in its entirety. Furthermore, the operand storage elements of the Caller can be renumbered so that the arguments are in proper order as expected by the target code segment. The actual transfer of control from the Caller to the target code segment can take place at the cycle boundary for next machine cycle, and the first instruction of the target code segment can be executed in this next machine cycle. The transfer of control back to the Caller involves a RETURN operation. The RETURN operation may include arguments that specify one or more result values or parameters that are to be returned to the Caller. When the RETURN operation is executed, these arguments can be evaluated in “Writer Phase” of the wide instruction containing the RETURN operation, and the actual transfer of control back to the Caller occurs at the cycle boundary for this “Writer Phase” operation. Such transfer of control can involve the spiller unit discarding the contents of operand storage elements (such as a belt or register file and possibly Scratchpad memory), restoring the saved contents of operand storage elements (such as a belt or register file and possibly Scratchpad memory) of the Caller and adding the return arguments to the operand storage elements (such as the front of the belt or to a register file) in the same way that a functional unit stores results. The returned-to wide instruction of the Caller can be re-executed in the same cycle, omitting those operations and phases that were already done.

In one embodiment, it is possible for a wide instruction to contain more than one CALL operation. In this case, the multiple CALL operations can be performed back to back, chaining into each other. Also, there can be several variants of the CALL operation (such as conditional CALL operations) that belong to the “Call Phase” operations. Furthermore, other operations (such as an INNER operation which can be used to enter a loop and described in detail in U.S. Prov. Patent Appl. No. 62/024,055, filed on Jul. 14, 2014 and herein incorporated by reference in its entirety) can belong to the “Call Phase” operations of the wide instruction.

The operations of the “Pick Phase” can include the PICK operation and the RECUR operation. The PICK operation selects between two operand values based on a predicate Boolean operand specified for the pick operation. The RECUR operation selects between two operand values based on a predicate Boolean operand specified by the recur operation being a NaR type or not, where the NaR type represents whether the value of the predicate Boolean operand is valid or reflects a previously detected error. The operations of the “Pick Phase” can be issued in the second machine cycle with respect to the issuance of operations of all phases of the given wide instruction. The “Pick Phase” operation(s) can issue for execution after issuance of both the “Compute Phase” operations and the “Call Phase” operations for the wide instruction. The “Pick Phase” operation(s) can access the results of operations for the phases prior to this phase, including the “Reader Phase” and “Compute Phase” and “Call Phase” of the same wide instruction (for the case where these operations retire prior to the issuance of the “Pick Phase” operation(s)). In one embodiment, the operations of the “Pick Phase” have zero latency because they are implemented in the renaming and rerouting functionality of the data crossbar circuit 205 (FIG. 3) and not in any functional unit slot. Furthermore, there is no pipeline and no inputs or new outputs. The wide instructions can contain dedicated encoding slots for the “Pick Phase” operation(s). The source operands and predicate Boolean operands for the “Pick Phase” operation(s) can be specified by an identifier (such as a belt position or register number), or possibly can be specified by an immediate value.

The operations of the “Writer Phase” can consume operand values (and not produce any result operand data values) and thus can be limited to pure data sinks. The operations of the “Writer Phase” can include conditional or non-conditional BRANCH operations as well as STORE operations that writes operand data to cache memory and other operations that writes operand data to fast local temporary storage managed separate from the cache memory (such as Scratchpad memory). The operations of the “Writer Phase” can be issued in the third machine cycle with respect to the issuance of operations of all phases of the given wide instruction. The operations of the “Writer Phase” can issue for execution after issuance of the “Compute Phase” operations, the “Call Phase” operations, and the “Pick Phase” operations for the wide instruction. The operations of the “Writer Phase” can include a CONFORM operation that reorders operand values to put them into the position that the next operations expect them to be. Note that RETURN operations can do this reordering themselves via specifying the return values. However, BRANCH operations do not perform this reordering, Nevertheless, the target code segment of the BRANCH operation can expect the operand storage elements to be arranged in a predefined manner (such as a specific order for the belt). For this reason there is the CONFORM operation that arranges operand storage elements in the way the target code segment of the BRANCH operation expects it to be. The operation is called CONFORM because usually there is a default arrangement that is established by the most common or original control transfer to the target code segment as established by the compiler. All other transfers into this target code segment must conform to this default arrangement. The CONFORM operation can invalidate operand storage values that are not explicitly reordered.

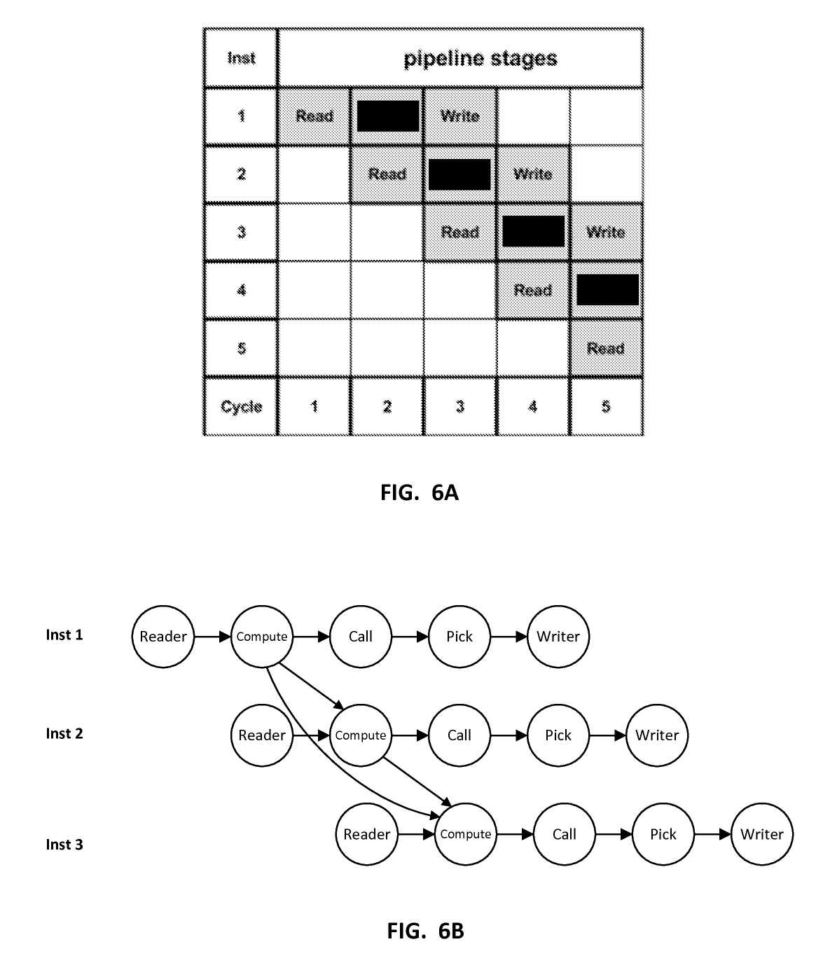

The functional units slots of the execution/retire logic 109 can be configured to execute the phases of operations for a sequence of wide instructions in a pipelined manner. An example of such pipelined execution of five wide instructions that include “Reader Phase”, “Compute Phase” and “Write Phase” operations is illustrated in FIG. 6A. Note that in this sequence, the “Reader Phase” operations of wide instruction 2 are issued in the same cycle as the “Compute Phase” operations of wide instruction 2 and the “Write Phase” operations of wide instruction 1. And barring stalls this is the steady state in the system, over branches and everything, the operations of the different phases from three different wide instructions are issued every cycle. The dataflow for this pipelined execution of the first three instructions (Inst 1, Inst 2 and Inst 3) in shown in FIG. 6B. Note that some of the directed edges between the phases of the instructions are omitted for simplicity of description. Also note that there can be directed edges that leading from one phase in execution of an instruction to a later phase in the execution of another instruction. Two of these directed edges are shown in FIG. 6B, one leading from the “Compute Phase” of Inst 1 to the “Compute Phase” of Inst 2 and the other leading from the “Compute Phase” of Inst 1 to the “Compute Phase” of Inst 3. Such directed edges between the phases represent the possible flow of data between two phases in separate instructions. Such flow is optional and need not be present in the program code.

Also note that the phases of operations can employ variations of the schemes described above. For example, certain operations of the “Reader Phase” (such as operations that read operand values from local temporary storage managed separate from cache memory (such as Scratchpad memory)) can issue in the second machine cycle with respect to the issuance of operations of all phases of the given wide instruction. In this case, the operands produced by such “Reader Phase” operations can be immediately and directly available such that they can be consumed by the operations in later issued phases (“Compute Phase, “Call Phase” or Pick Phase” operations) of the wide instruction (or subsequent instructions, if available).

In one embodiment, the CPU can use temporal addressing for the storage of transient intermediate operands as described in U.S. patent application Ser. No. 14/312,159, filed on Jun. 23, 2013, and incorporated by reference above in its entirety. Such temporal addressing models a random access conveyor belt of transient operands. Results of operations are injected on the front of the belt, move along as later results are also injected, and eventually fall off and disappear when they reach the end of the belt queue. This is a conceptual model as seen by the software; the actual hardware need not physically model such a conveyor. Belt operands are addressed by belt position where position zero is the most recent operand to have been injected. Operands are injected onto the belt by a variety of producer-type operations, including ordinary operations such as ADD, READER, memory LOAD, etc. Likewise, consumer-type operations consume operands from the belt. Such consumer-type operations can include ordinary operations such as WRITE, and memory STORE. The actual routing of operands produced by functional unit carrying out a producer-type operation to the belt and from the belt to a functional unit carrying out a consumer-type operation takes place at cycle boundaries using a multiplexer network, which is referred to herein as a crossbar or interconnect network. The realities of this circuitry prevents any sub-cycle granularity of operand handling.

When an expression such as “A+B−C” requires a transient intermediate (A+B) that is the result of one operation (the addition) and the argument of a second (the subtraction), the addition and subtraction operations occupy a full cycle each, and the transient is routed through the crossbar at the boundary between those cycles. However, the A, B and C operands must come from somewhere and themselves be placed on the belt. For this example we will assume that they come from registers where they had been left by prior computation.

The CPU can perform the following operations to evaluate the expression “A+B−C”:

1. The operands A and B are fetched from registers by READER operations and injected into the belt.

2. At the cycle boundary, the operands at belt positions B0 (B) and B1 (A) are routed to an adder functional unit.

3. The adder functional unit takes a cycle to execute an ADD operation, produce the sum, and inject the resultant sum into the belt.

4. Meanwhile, the operand C is fetched from registers by a READER operation and also injected into the belt.

5. At the cycle boundary, the operands at belt positions B0 (C) and B1 (A+B) are routed to a subtracter functional unit.

6. The subtracter functional unit takes a cycle to execute a SUB operation and inject the difference result into the belt.

Hence, the actual execution timing is:

X₀: READER(A); READER(B);
---------------------------------
X₁: ADD(b0, b1); READER(C);
---------------------------------
X₂: SUB(b0, b1);

In this example, X_{N} is a cycle number, all operations on one line are executed in parallel in the indicated cycle, and “ - - - ” indicates a cycle boundary during which the belt operands are routed for consumption by the appropriate consumer-type applications.

While this timing is what the machine is actually doing, directly mapping the machine timing into instruction encodings is notationally inconvenient both at the assembler source level and as encoded in operations. Operations that are in a single wide instruction issue in parallel on the CPU, while the wide instruction is the unit of flow of control.

Consequently, if this code is the target of a BRANCH operation then the BRANCH operation will refer to the wide instruction containing the two READER operations. It then takes three cycles after the BRANCH operation for the result of SUB operation to be available. However, the CPU can make the result of the SUB operation to be available in only two cycles. The extra cycle can be gained because the instruction encoding permits decode of certain kinds of operations to take less time (in cycles) then does decoding other kinds of operations. In one embodiment, all the computational operations like ADD and SUB take three cycles to decode. However, READER operations take only two cycles. Consequently, if a wide instruction contains both a READER operation and an ADD operation then the READER operation is ready to issue one cycle before the ADD operation is. In this case, the actual wide instructions encoded for this code are:

READER(A); READER (B); ADD(b0, b1);
READER(C); SUB(b0, 1).

In this example, each line is a wide instruction even though the inter-operation timing is as before. The READER operations decode and issue a cycle before the others, even though (or rather, because) they are in the same wide instruction. This is not only a notational convenience, it actually saves a cycle. The READER operations for A and B can actually execute in the same cycle as the entering BRANCH operation, whereas before they had a cycle to themselves. It is as if each cycle had been split into sub-cycle phases, where all READER operations execute in the first phase and all computation operations in the second phase, and operations in the second phase can see the results of operations in the first phase. This phase model has no physical reality—it is not possible in hardware to subdivide a cycle. But the relative issue timing of different kinds of operations provides the illusion of phasing, and phases provide a convenient and clear description of the execution of the operations by the CPU.

In one embodiment, the CPU employs six phases: a “Reader Phase,” an “Exu Phase” (which is analogous to the “Compute Phase” as described above), a “Call Phase,” a “Pick Phase,” a “Flow Phase” (which is analogous to the “Writer Phase” as described above), and a “Promote Phase.” Operations in each of these six phases can use the results of the prior phase as arguments.

The READER operation executes in the “Reader Phase” and in the previous machine cycle. The READER operation can get an operand from storage (such as a register, streamer, or constant ROM) and return it as the result on the belt.

All computation operations (including ADD and SUB as discusses above) execute in the “Exu Phase.” Unlike READER operations they have arguments, which can come from the Reader Phase operations or from the results of operations in prior instructions. There are hundreds of different computational operations.

The CALL operation executes in the “Call Phase.” Consequently, (for example), a CALL operation can use the result of an ADD operation in the same instruction as an argument. CALL operations cannot be executed in parallel with other CALL operations for a given instruction. Instead, an instruction with more than one CALL operation can execute each CALL operation in sequence or execute a select one of the CALL operations. Consequently, there may be more than one “Call Phase.” Later CALL operations can use the results of earlier ones as arguments.

The PICK operation executes in the “Pick Phase.” The PICK operation conditionally selects one of two operands based on a Boolean selector operand. While the PICK operations encodes like an operation it is actually performed as data moves through the crossbar to the consumers at the cycle boundary. That is, it executes in zero cycles, as explained elsewhere.

Memory references (e.g., memory STORE operations) and control flow operations (BRANCH operations) and WRITER operations execute in the “Flow Phase.” The WRITER operations send operands to operand storage (such as registers and streamers).

Lastly, PROMOTE operations execute in the “Promote Phase.” The PROMOTE operation renumbers the contents of the belt so that belt operands appear in a different order for the next instruction.

These phases are strongly ordered as given above. The phase ordering dictates what operation chains may be encoded in a single instruction. For example, the code A=F(B+C) encodes to:
READER(B); READER(C); ADD(b0, b1); CALL(b0); WRITER(b0, A).
   In this example, all five operations are in one instruction, because each result is consumed by an operation only in a later phase. The timing of execution of the phases is given as:

X₀: READER(B); READER(C);
---------------------------------
X₁: ADD(b0, b1); CALL(b0); // flow of control of call
---------------------------------
X₂: ... // first callee instruction\
---------------------------------
... // instructions of callee
---------------------------------
X_{N}: RETURN(...);
---------------------------------
X_{N+1}: WRITER(b0, A);

In this example too, X_{N} is a cycle number, all operations on one line are executed in parallel in the indicated cycle, and “ - - - ” indicates a cycle boundary during which the belt operands are routed for consumption by the appropriate consumer-type applications.

In contrast the code A=F(B)+C encodes as:

READER(B); CALL(b0);
READER(C); ADD(b0, b1); WRITER(b0, A);

Note that this example takes two instructions because the result of CALL operation (which executes in the “Call Phase”) is consumed by the ADD operation (which executes in the “Exu Phase,” which is earlier than the “Call Phase” in the phase order), and hence must lie in a different instruction and be separated by a cycle boundary from the CALL operation. The timing of execution of the phases is given as:

X₀: READER(B); CALL(b0); // flow of control of call
---------------------------------
X₁: ... // first callee instruction
---------------------------------
... // instructions of callee
---------------------------------
X_{N}: RETURN(?); READER(C);
---------------------------------
X_{N+1}: ADD(b0, b1);
---------------------------------
X_{N+2}: WRITER(b0, A);

In this example too, X_{N} is a cycle number, all operations on one line are executed in parallel in the indicated cycle, and “ - - - ” indicates a cycle boundary during which the belt operands are routed for consumption by the appropriate consumer-type applications. If we consider the cycle that contains the “Exu Phase” of an instruction (and issues operations like ADD) as “the” cycle of the instruction, then the “Reader Phase” operations execute a cycle earlier, the “Call Phase” operations a cycle later, the “Pick Phase” operations on the next cycle boundary (after the “Exu Phase,” or after the return of the called function if there was one), and the operations of the “Flow Phase” and “Promote Phase” in the cycle after the “Pick Phase” boundary. This spreads the operations of a single instruction over three cycles, or many more if the instruction contains one or more CALL operations.

The CPU provides the illusion that operations in each of these phases produce results (if they do) that are visible to and can be arguments to operations in later phases.

Consider the expression A=B+C, where A, B, and C are in the general registers. Executing this expression requires four operations—two READER operations (pure producers), an ADD operation (both a consumer of arguments and a producer of a result), and a WRITER operation (a pure consumer). The model above can work such that the READER operations produce their results one cycle ahead of when the ADD consumes those operands as arguments. It also works such that the ADD operation produce its result one cycle ahead of when the WRITER operation consumes it. The only question is whether the argument consuming action of the ADD operation is in the same cycle as the production of its result, and that depends on the latency of the ADD operation.

Operation latencies can vary. In one embodiment, basic integer operations like the ADD operation can be configured to have a latency of one machine cycle and can produce their result in the same cycle as they consume their arguments. This example will assume this latency. Consequently, executing this expression takes place over three cycles: one (hereinafter X0) where the READER operations produce the two register operands onto the belt; one (X1) where the ADD operation consumes the arguments into the adder function unit and produces the result to (a different position on) the belt; and one (X2) where the WRITER operation consumes the final operand back to a register. In this example, all four operations can be encoded in a single wide instruction as follows:
READER(B); READER(C); ADD(b0, b1); WRITER(b0, A).
   Here, the decode stage of the CPU is configured to scatter the issue of the operations of the instruction over three cycles based on the kind of operation. Specifically, the computational operations issue in the main instruction cycle, X1 in this example. The issuance of READER operations is advanced one cycle, the X0 cycle. The issuance of WRITER operations is retarded one cycle, the X2 cycle. In this manner, the issue of the operations of the one instruction is scattered over three consecutive machine cycles.

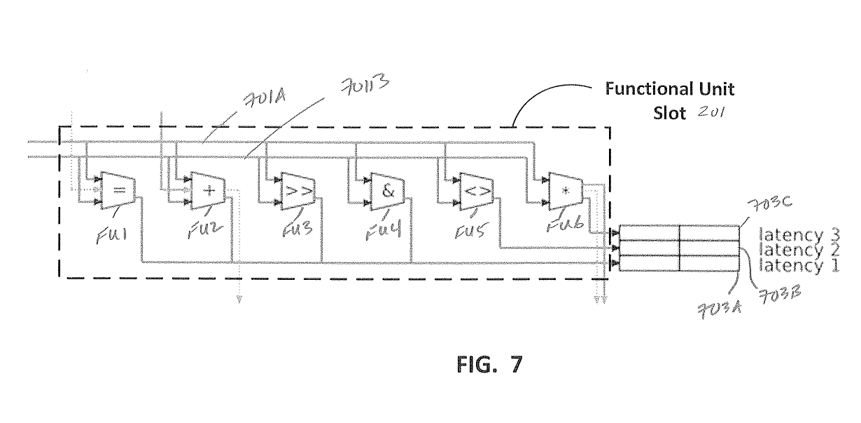

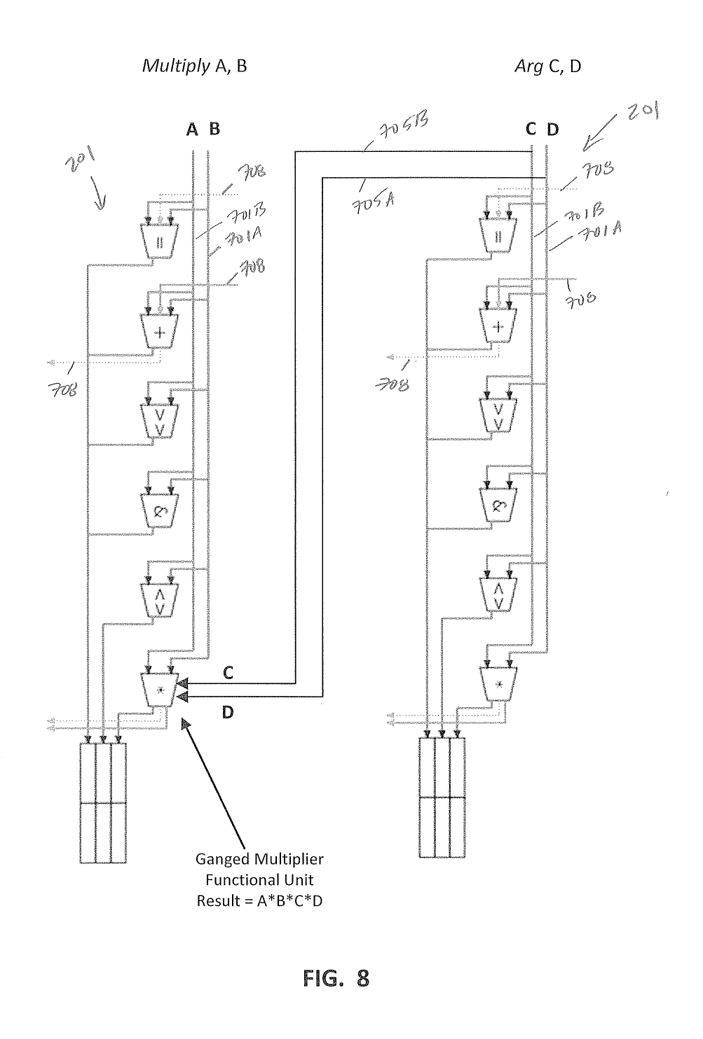

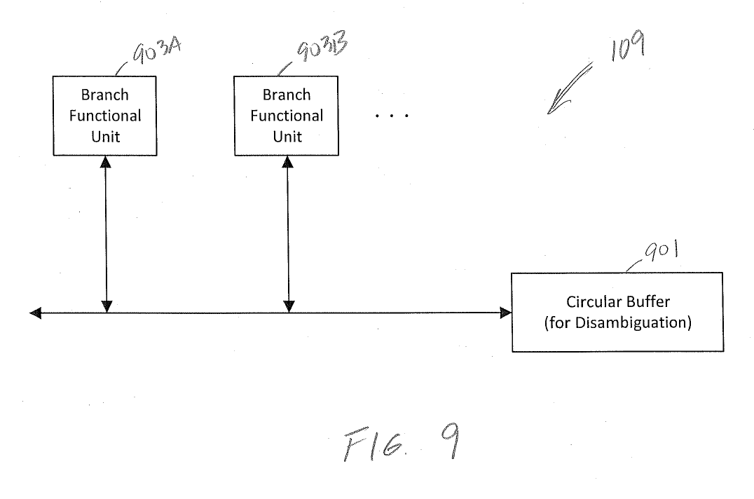

The functional units slots 201 of the execution/retire logic 109 of the CPU/Core 102 include a grouping of one or more functional units. Furthermore, one or more functional unit slots of the execution/retire logic 109 of the CPU/Core 102 (particularly those functional unit slots that consume operand data) can employ a number of functional units that share a common set of input data paths. For example, FIG. 7 shows an example of a functional unit slot 201 that includes six functional units that share a common set of two input data paths 701A, 701B. The six functional units are configured to perform various different arithmetic operations on two source operand values that are input over the input data paths 701A, 701B, such as a comparison operation whose result represents the equality of the two source operand values as performed by FU1, an addition operation whose result represents the addition of the two source operand values as performed by FU2, a comparison operation whose result represents whether one of the two source operand values is greater than the other of the two source operand values as performed by FU3, a bitwise operation whose result is the bitwise AND function of the two source operands as performed by FU4, comparison operation whose result represents the inequality of the two source operand values as performed by FU5, and a multiplication operation whose result represents the multiplication of the two source operand values as performed by FU8.

Note that the width of the input data paths can vary amongst the functional unit slots and correspond to the number of bits of operand data that is consumed by the functional units of the respective functional unit slots in carrying out their particular operations.

The functional units of each respective functional unit slot 201 contain circuits like multipliers, adders, shifters, circuits for floating point operations, and circuits for functional call operations, branches, loads from memory and stores to memory. The functional units of each respective functional unit slot 201 are generally grouped to correspond to the particular phase of operations that the functional units of the respective functional unit slot implement and also depends on which encoding slot issues the operations to them. Consequently the different encoding slots in the instructions processed by the CPU encode the operations for different kinds of slots (where the kinds of slots correspond to the particular phases of operations that the functional units of the respective functional unit slots implement).

The operations that are executed by the one or more of the functional unit slots can have different latencies, i.e. they take a different amount of machine cycles to complete. In this case, the functional units of the respective functional unit slot can be fully pipelined to allow each functional unit in the respective functional unit slot to be issued one new operation every machine cycle.

Furthermore, there can be a limited number of dedicated data sink registers for each particular functional unit slot that produces operand values for further consumption where such data sink registers are writable only by the functional units in the particular functional unit slot. The data sink registers can be even more specialized for the case that there are operations of different latency that can be executed by the functional units within a functional unit slot. In this case, there are dedicated registers for the functional unit slot that are writable only by functional units of a specific latency. For example, FIG. 7 shows an example of a functional unit slot 201 with three sets of data sink registers 703A, 703B, 703C that correspond to different latencies (specifically, a one machine cycle latency for the set of data sink registers 703A, a two machine cycle latency for the set of data sink registers 703B, and a three machine cycle latency for the set of data sink registers 703C). In one embodiment, these same dedicated registers can also serve as source registers for the functional unit slots of the execution/retire logic 109. In this case, the data crossbar network 205 of the execution/retire logic 109 can include a global addressing mechanism that can be configured to make the dedicated registers available to the input data paths of any one of the functional unit slots of the execution/retire logic 109. The data crossbar network 205 can also provide short specialized fast paths for one latency operation results, so that they can be immediately consumed the next cycle by the next one latency operation in another functional unit slot after they were produced.

The set of dedicated registers for a functional unit slot that are writable only by functional units of a specific latency can be used to accommodate function calls or interrupts. In this case, the operations executing in the target code segment can employ some of these dedicated registers to store their results, while the operations still executing in the Caller can employ other ones of these dedicated registers to store their results as well. And the results from the Caller stored in such dedicated registers can possibly be used as sources for subsequent operations when the control flow returns from the target code segment or interrupt.

The functional units of the respective functional unit slots interact with each other primarily by exchanging operands over the data crossbar network 205 where the result of one operation become the operand(s) for the next operation and delivered to the data input path(s) for the functional unit slot that will execute the next operation.

Note that certain complex operations can require more source operands than can be provided by the set of input data paths of a respective functional unit slot. In order to address this problem, neighboring functional unit slots can be connected with interconnecting data paths. One or more “Ganged” functional units can utilize these interconnecting data paths between two neighboring functional unit slots such that the “Ganged” functional unit operates as part of the two neighboring functional slots. For such cases, the input data paths for the neighboring functional unit slots and the interconnecting data between such neighboring functional unit slots can be used to supply the source operands required for the complex operation to the “Ganged” functional unit that will execute the complex operation.

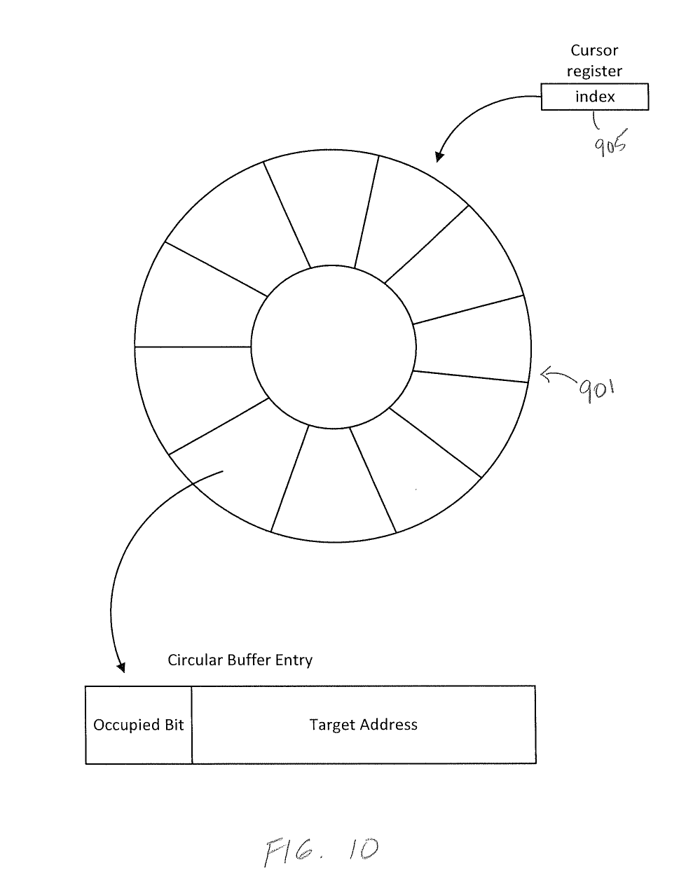

FIG. 8 shows an example where two neighboring functional unit slots include a “Ganged” functional unit for arithmetic multiplication operations. The two neighboring functional unit slots each include two input data paths 701A, 701B as shown. The four input data paths for the neighboring functional unit slots and the interconnecting data paths 705A, 705B between such neighboring functional unit slots can be used to supply up to four source operands to the “Ganged” functional unit. The operation of the “Ganged” functional unit can be activated by special operations. For example, one of the neighboring functional unit slots can be configured based on a slot encoding that represents the operation with arguments that specifies one or two source operand inputs, and the other one of the neighboring functional unit slots can be configured based on a slot encoding that represents a dummy operation (which can be referred to as an ARG operation) with arguments that specifies two other source operand inputs. In this manner, the one or two source operand inputs along with the two other source operand inputs are routed to the “Ganged” functional unit in order to supply the source operands required for the complex operation performed by the ganged functional unit. In the example shown in FIG. 8, the functional unit slot on the left side of the page can be configured based on a slot encoding that represents the multiply operation with arguments that specify two source operand inputs “A” and “B”, while the neighboring functional unit slot on the right side of the page is configured based on a slot encoding that represents the ARG operation with arguments that specify two other source operand inputs “C” and “D”. In this case, the two source operand inputs “A” and “B” along with the two other source operand inputs “C” and D” are routed to the “Ganged” functional unit for the arithmetic multiplication operation in order to supply the source operands required for the complex operation (A*B+C*D) performed by the “Ganged” functional unit. Note that the interconnecting data paths 705A, 705B are configured to carry the source operand inputs “C” and D” to the “Ganged” functional unit for the complex multiply operation.

Furthermore, there can be simple and fast data connections between functional unit slots. Examples of these data connections are labeled as 706 in FIG. 8. These data connections can be activated only by special operations in order to pass condition codes, input operands, transient results, and/or operation state predicates from one functional unit slot to another functional unit slot without going through the data crossbar network 205, even within the same cycle within the same phase. In one embodiment, a special operation referred to as a GRT* operation can be executed by a given functional unit slot where the given functional slot receives the greater than condition code result generated by a neighboring functional unit slot and communicated over a data connection from the neighboring functional unit slot to the given functional unit slot. The given functional slot stores the received greater than condition code result for subsequent use (for example, by dropping the received greater than condition code result onto the front of a logical belt as described in U.S. patent application Ser. No. 14/312,159, on Jun. 23, 2014, commonly assigned to the assignee of the present application and incorporated by reference above in its entirety, or storing the received greater than condition code result in some other local storage register). The neighboring functional unit slot generates the greater than condition code result automatically as part of executing an operation. For example, the neighboring functional unit can execute an add operation and generate a greater than condition code result that is “true” if and only if the result of the add operation is greater than zero. The condition code result generated by the neighboring functional unit slot can be passed over the data connection from the neighboring functional unit slot irrespective of whether the adjacent functional unit slot is processing a GTR* operation or not. The condition code result is the product of many value producing operations. The condition code results are status flags that can are traditionally kept in a global status register, and each operation that produces status flags replaces the previous value. Alternatively, the global status flag register can be omitted. Instead, only when the program actually needs one or more of these condition codes, as determined by the compiler, is the condition code stored in the operand storage elements for subsequent use as a normal argument. Examples of common condition codes include carry, overflow, fault, equal, not-equal, greater-than, greater-than-or-equal, less-than, and less-than-or-equal. These data connections can also be used for the moving the results stored in the dedicated registers of some other functional unit slot (such as a neighboring functional unit slot) into the dedicated registers of a given functional unit slot in case the dedicated registers of the other functional unit slot are full.

Note that the phases of operations as described herein determines the order that operations issue for execution within a given wide instruction, not the order that such operations retire in. While a majority of operations only take one cycle, and there the issue order indeed defines the retire order, there are many operations that do not. Static scheduling techniques performed at compile time can be used to put the operations in the proper instruction to order their retire times appropriate for the program order.

Also note that the difference between the issue and retire cycle for the phases of operations makes the cycle saving gains of phasing across control flow possible. For example, the “Writer Phase” operations of a wide instruction and the “Reader Phase” operations of the next wide instruction can issue for execution in the same machine cycle as “Reader Phase” operations because such “Reader Phase” operations cannot depend on operands or results produced by the “Writer Phase” operations of the previous wide instruction. Thus, it is always safe to start decoding and issuing such “Reader Phase” operations.

It is also contemplated that certain operations (which are referred to as “split-phase operations”) can include multiple actions as part of their overall effect and these multiple actions occur in different phases. One example of such a split-phase operation is the STORE operation which involves one action where an effective address is evaluated and/or computed (this can occur in the “Compute Phase”) and another action where the operand data value to be stored together with the evaluated/computed effective address is used to generate a store request that is issued to the cache of the hierarchical memory system (this can occur in the “Writer Phase”) in order to store the operand data value in the hierarchical memory system. For example, one or more functional unit slots of the execution/retire logic 109 can include a load/store functional unit that is configured to perform the actions of the split-phase STORE operation. In this case, the STORE operation can be issued to the load/store functional unit such that the load/store unit evaluates and/or calculates the effective address in the “Compute Phase” and then evaluates the value to be stored and in the following “Writer Phase” and uses the effective address and value to generate a store request that is issued to the cache of the hierarchical memory system in the following “Writer Phase” in order to store the operand data value in the hierarchical memory system. In this manner, the actions of the load/store functional unit are pipelined to occur in the consecutive machine cycles of the “Compute Phase” and the “Writer Phase” of the wide instruction that contained the split-phase STORE operation.

The execution/retire logic 109 can also execute operations speculatively. In one embodiment, such speculative execution of operations is supported by scalar and vector-type operand elements having special meta-data that allows the operand elements to be marked as invalid (Not a Result; NaR) or missing (None). Individual elements in the vector-type operand elements can be NaR or None. Details of such meta-data is described in U.S. patent application Ser. No. 14/567,820, filed on Dec. 11, 2014, commonly assigned to assignee of the present application and herein incorporated by reference in its entirety. In this case, the execution/retire logic 109 can speculate through errors, as errors are propagated forward. A fault is realized by an operation with side effects, e.g. a store or branch. A load from inaccessible memory does not fault; it returns a NaR. If you load a vector and some of the elements are inaccessible, only those are marked as NaR. NaRs and Nones flow through speculable operations where they are operands. If an operand element is NaR or None, the result is always NaR or None. If you try and store a NaR, or store to a NaR address, or jump to a NaR address, then the CPU faults. NaRs contain a payload to enable a debugger to determine where the NaR was generated. Floating point exceptions are also stored in the meta-data of the operand elements. The exceptions (invalid, divide-by-zero, overflow, underflow and inexact) are ORed in operations, and the flags are applied to the resulting meta-data only when values are realized. The instruction set architecture of the CPU/Core 102 can include operations that explicitly test for None, NaR and floating point meta-data. Note that None is technically a kind of NaR. In other words, there are several kinds of NaR and the kind is encoded in the meta-data bits. A debugger can differentiate between memory protection errors and divide by zeros, for example, by looking at the kind bits. The remaining bits in the operand are filled with the low-order-bits of a hash identifying the operation which generated the NaR, so the debugger can usually determine this too even if the NaR has propagated a long way. The None has a higher precedence over all other kinds of NaR so if you perform arithmetic with NaR and None values the result is always None. Thus, None is used to discard and mask-out speculative execution.

The CPU/Core 102 can also employ a prediction mechanism that is configured to prefetch and/or fetch cache lines of the instruction stream in the face of branch operations and function call operations in order to avoid stalls. In one embodiment, the CPU/Core 102 can employ an exit table structure that predicts exit points where control flow leaves program block segments (referred to as an EBB) as described in U.S. patent application Ser. No. 14/539,087, on Nov. 12, 2014, commonly assigned to the assignee of the present application and herein incorporated by reference in its entirety.

The prediction mechanism can also function to detect mispredicts and deal with them. In one embodiment, this is accomplished by tacking the memory address of each given wide instruction as well as the memory address of next wide instruction should this one falls through (whether fall-through is predicted or not) to the given wide instruction in both decode and execution stages of the CPU/Core 102. In this manner, these addresses flow along with the wide instruction through decode and into execution. If the wide instruction contains a conditional branch operation, then the branch functional unit determines whether the predicate condition of the conditional branch operation is true as well as the effective target address of that branch operation. There can possibly be multiple taken branch operations that are due to retire in a machine cycle. A disambiguation rule can be used to select one of these multiple taken branch operations and retire the selected one branch operation such that control follows to the target address of this selected branch operation. If there is no taken branch operation in this cycle (no branches existed or none were taken), then the address for the next instruction is selected as the fall-through address attached to this wide instruction. The selected address of the next instruction is then compared against the predicted address of the next instruction. If this address comparison fails then a mispredict is detected. In the case of a mispredict, the contents of the decode stage and execution stage that involve operations down the wrong path can be discarded, and the selected (correct) memory address for the next instruction can be used by the prediction mechanism to begin fetching and decoding on the correct path.

In one embodiment, the phases of operations processed by the CPU/Core 102 can include a deferred conditional BRANCH operation where the retire cycle of the deferred conditional BRANCH operation (i.e., the machine cycle where the target address of the conditional BRANCH operation is used to update the control flow of the instruction processing pipeline for the case where the conditional predicate of the BRANCH instruction is evaluated as taken) occurs a number of machine cycles after the issue cycle of the deferred conditional BRANCH operation. The deferred execution of the conditional BRANCH operation is similar to the deferred LOAD operation as described in International Appl. No. PCT/US14/60661, filed on Oct. 15, 2014, herein incorporated by reference in its entirety.

The schedule latency for the deferred conditional BRANCH operation can be controlled by encoding statically-known cycle count data in the machine code of the deferred conditional BRANCH operation. The cycle count data explicitly represents the desired schedule latency in zero or more machine cycles. The count is counted down with each machine cycle, and the schedule latency expires when the count reaches zero. This mechanism is suitable for circumstances for which is it possible to statically know the number of machine cycles between the desired point of issue of the conditional BRANCH operation and the desired point of retire of the conditional BRANCH operation.

Alternatively, the schedule latency for the deferred conditional BRANCH operation can be controlled by encoding a statically assigned operation identifier (or “op ID”) in the machine code of the deferred conditional BRANCH operation. At some subsequent point, the instructions processed by the CPU/Core 102 includes a separate PICKUP operation carrying the same operation identifier, which defines the retire point of the original conditional BRANCH operation. The execution of the PICKUP instruction controls the schedule latency of the deferred conditional BRANCH operation. This mechanism is suitable for circumstances for which is it not possible to statically know the number of machine cycles between the desired point of issue of the conditional BRANCH operation and the desired point of retire of the conditional BRANCH operation.

It is possible that the phases of operations (such as the “Writer Phase as described above) processed by the CPU/Core 102 can include multiple deferred conditional BRANCH operations which originate from different wide instructions such that the schedule latency for multiple taken BRANCH operations expires in the same machine cycle. In other words, these multiple taken BRANCH operations are set to retire in the same machine cycle. In order to address this issue, the execution/retire logic 109 of the CPU/Core 102 can be configured to implement a disambiguation rule that selects one of these multiple taken BRANCH operations and retires the selected one taken BRANCH operation such that the target address of the selected one taken BRANCH operation is used to update the control flow of the instruction processing pipeline.

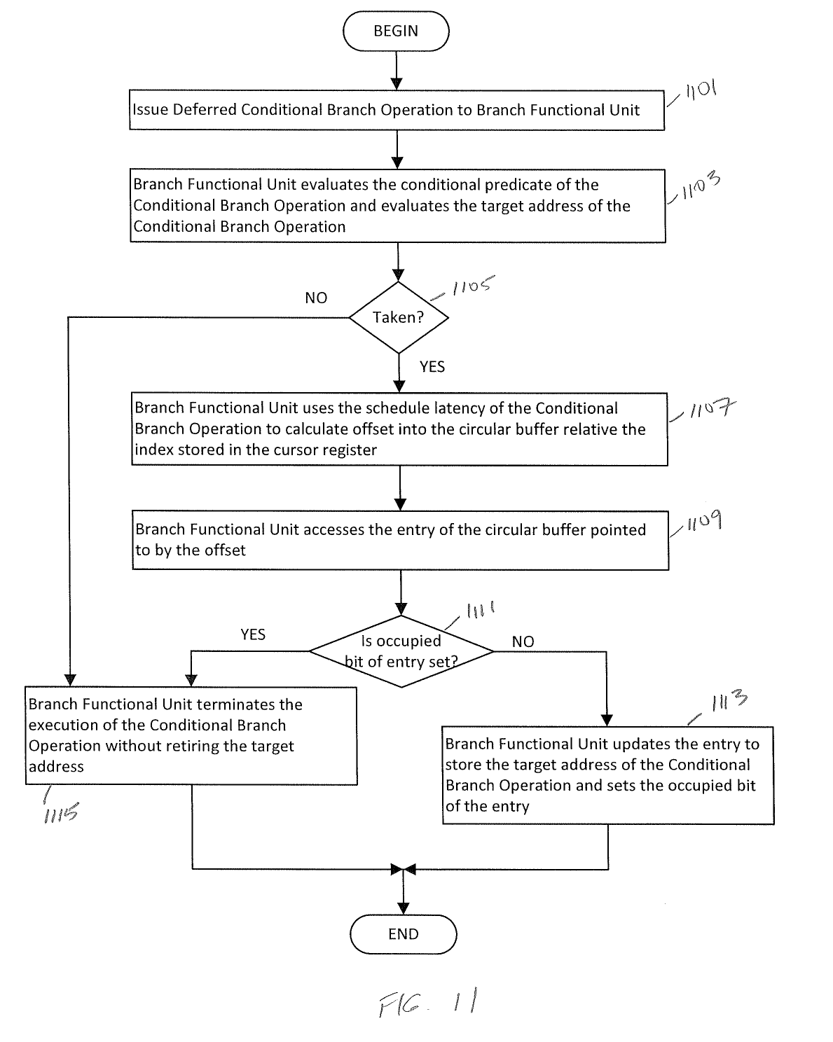

One disambiguation rule that is suitable for handling deferred conditional BRANCH operations with statically-known schedule latencies can be referred to as “first branch taken wins” or “FBT”. In FBT, the first conditional BRANCH operation that is evaluated as taken wins amongst multiple taken BRANCH operations that are set to retire in the same machine cycle. In one embodiment, FBT can be implemented with circular buffer 901 that interfaces to multiple branch functional units (for example, two labeled as 903A, 903B) as part of the execution/retire logic 109 of the CPU/Core 102 as shown in FIG. 9. The circular buffer 901 has an associated cursor register 905 that holds an index to one of the entries of the circular buffer 901 as shown in FIG. 10. The offset of each entry of the circular buffer 901 relative to the index stored in the cursor register 905 corresponds to a schedule latency (in machine cycles) relative to the current machine cycle. Each entry of the circular buffer 901 can hold a target address of a deferred conditional BRANCH operation and an occupied bit as shown in FIG. 10. The occupied bit for the entry is set when the entry holds such a target address; otherwise, the occupied bit is cleared.

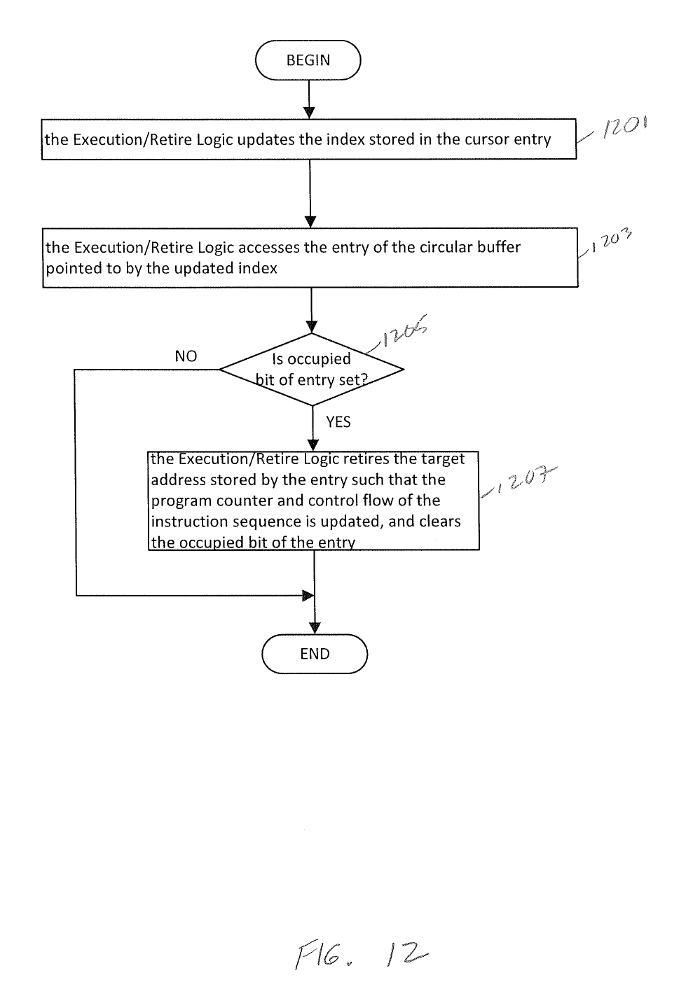

As illustrated in the flowchart of FIG. 11, each conditional BRANCH operation encoded by a wide instruction is decoded and then issued to one of the branch functional units (e.g., 903A or 903B of FIG. 9) in block 110 for execution in a particular phase (such as the Writer Phase). The branch functional unit evaluates the conditional predicate of the BRANCH operation in this particular phase in block 1103. It also evaluates the target address of the BRANCH operation in block 1003. The branch functional unit checks whether the conditional predicate of the BRANCH operation is true in block 1105. If so, the operations continue to blocks 1107 to 1111. Otherwise, the operations continue to block 1115 where the branch functional unit can terminate the execution of the BRANCH operation without retiring the BRANCH operation.

In block 1107, the branch functional unit uses the statically-known schedule latency of the conditional BRANCH operation (which can be specified by statically-known cycle count data encoded in the machine code of the deferred conditional BRANCH operation as described herein) to derive an offset relative to the index held in the cursor register 905. In block 1109, the branch functional unit accesses the entry of the circular buffer 901 positioned at this offset to check whether this entry holds a target address with an occupied bit set in block 1111. If so, the operations can continue to block 1115 where the branch functional unit can terminate the execution of the BRANCH operation without retiring the BRANCH operation. However, if it is determined that the occupied bit is cleared in block 1111 (thus the entry does not hold a target address with an occupied bit set), the operations can continue to block 1113 where the entry can be updated to store the target address of the taken BRANCH operation and the occupied bit set. In effect, this operation stores the target addresses of the first taken BRANCH operation at this entry.

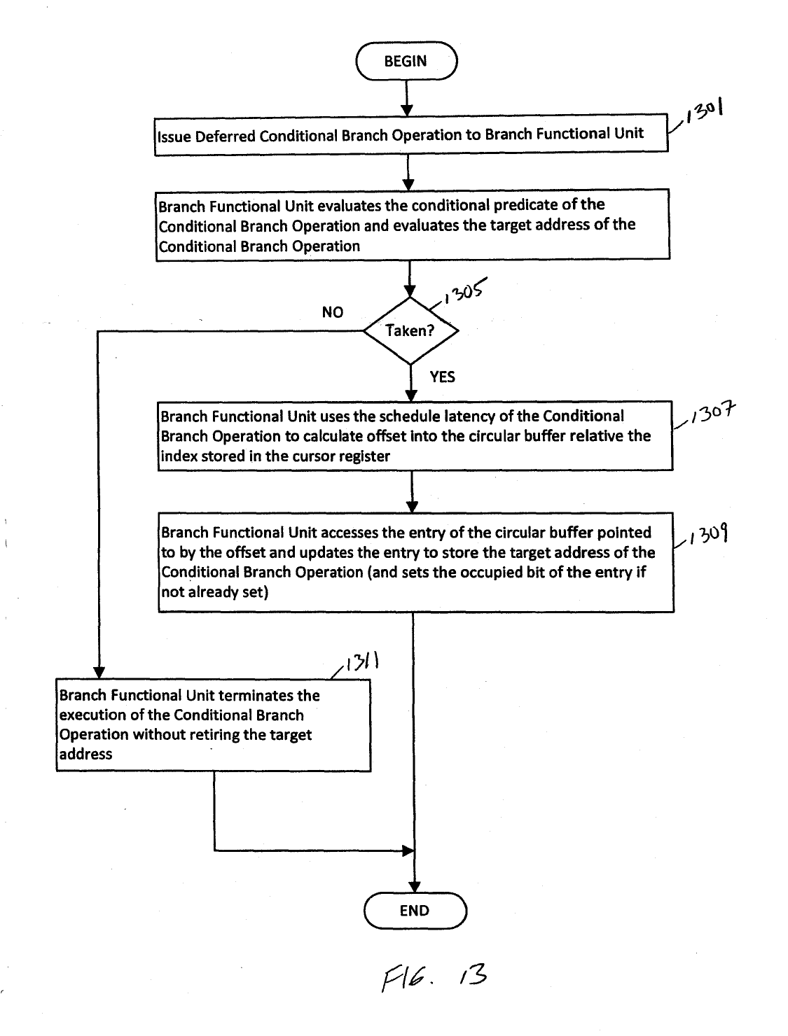

The flowchart of FIG. 12 illustrates the operations carried out by the execution/retire logic 109 of the CPU/Core 102 for each machine cycle. These operations can be carried out on the cycle boundary following the predefined phase of operations (such as the Writer Phase) in which conditional BRANCH operations execute. In block 1201, the index stored in the cursor is advanced (circularly). With each update of the cursor, the entry of the circular buffer pointed to by the updated cursor is checked in block 1203 to determine if the occupied bit of this entry is set in block 1205. If the occupied bit of this entry is not set, the operations end. If the occupied bit of this entry is set, the operations continue to block 1207 where the target address for this occupied entry becomes the new execution address for updating the program counter and the occupied bit is cleared; that is, the taken BRANCH operation is retired and control flow transfers to the target address of the taken BRANCH operation. These operations retire the first taken BRANCH operation that is set to retire in the given machine cycle and control flow transfers to the target address of the first taken BRANCH operation.

Another disambiguation rule that is suitable for handling deferred conditional branch operations with statically-known schedule latencies can be referred to as “last branch taken wins” or “LBT”. In LBT, the last conditional BRANCH operation that is evaluated as taken wins amongst multiple taken BRANCH operations that are set to retire in the same machine cycle. In one embodiment, LBT can be implemented with a circular buffer 901 and an associated cursor register 905 that holds an index to one of the entries of the circular buffer as described above with respect to FIGS. 9 and 10 for FBT. The offset of each entry of the circular buffer 901 relative to the index stored in the cursor register 905 corresponds to schedule latency (in machine cycles) relative to the current machine cycle. Each entry can hold a target address of a deferred conditional BRANCH operation and an occupied bit similar to FBT.

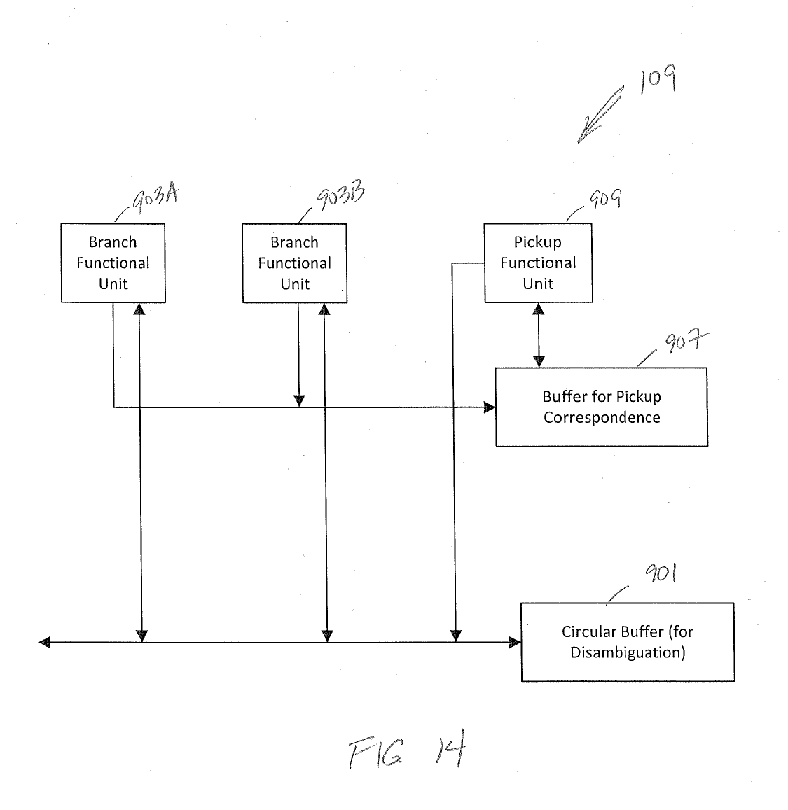

As illustrated in the flowchart of FIG. 13, each conditional BRANCH operation encoded by a wide instruction is decoded and then issued to a branch functional unit in block 1301 for execution in a particular phase (such as the Writer Phase). The branch functional unit evaluates the conditional predicate of the BRANCH operation in this particular phase in block 1303. It also evaluates the target address of the BRANCH operation in block 1303. The branch functional unit checks whether the conditional predicate of the BRANCH operation is true in block 1305. If so, the operations continue to blocks 1307 to 1309. Otherwise, the operations continue to block 1311 where the branch functional unit can terminate the execution of the BRANCH operation without retiring the BRANCH operation.

In block 1307, the branch functional unit uses the statically-known schedule latency of the conditional BRANCH operation (which can be specified by statically-known cycle count data encoded in the machine code of the deferred conditional BRANCH operation as described herein) to derive an offset relative to the index held in the cursor register. In block 1309, the branch functional unit then updates the entry of the circular buffer positioned at this offset to hold the target address of the taken branch instruction (and set the occupied bit if not already set). In effect, this overrides the previous insertion of a target addresses at this entry such that entry stores the target address for the last taken BRANCH operation.

The operations of FIG. 12 are carried out by the execution/retire logic 109 of the CPU/Core 102 for each machine cycle in order to retire the last taken BRANCH operation that is set to retire in the given machine cycle and control flow transfers to the target address of the last taken BRANCH operation.

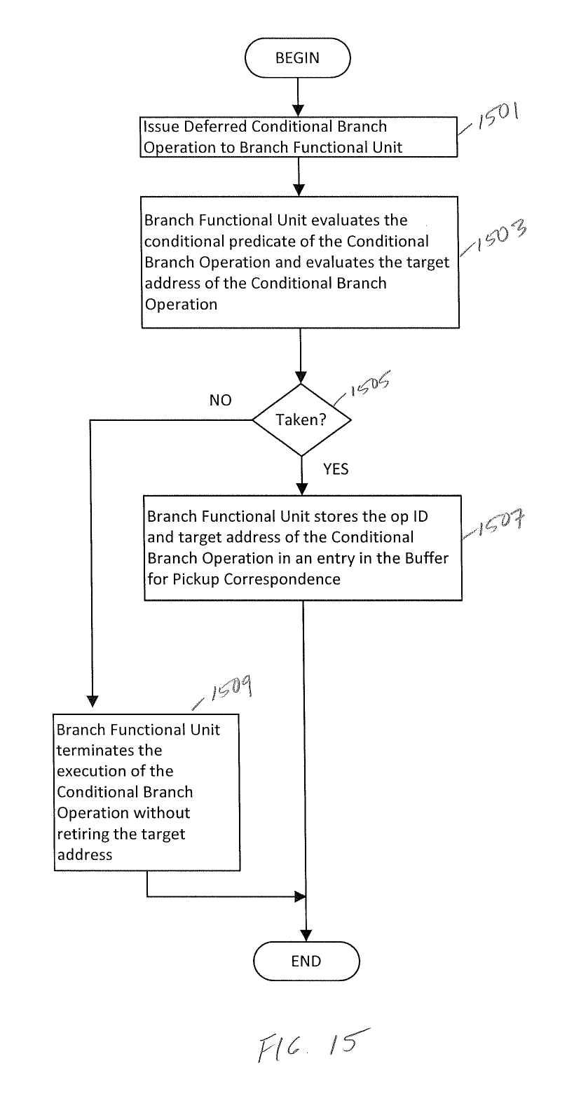

The disambiguation rule(s) as described herein can also be extended to handle deferred conditional BRANCH operations with statically unknown schedule latencies. FIG. 14 illustrates an exemplary implementation that extends LBT to handle deferred conditional BRANCH operations with statically unknown schedule latencies. In this case, the schedule latency of a given conditional BRANCH operation is dictated by the execution of a PICKUP operation whose encoding included an operational identifier shared with the encoding of the given conditional BRANCH operation. In this embodiment, circular buffer 901 interfaces to multiple branch functional units (for example, two labeled as 903A, 903B) as part of the execution/retire logic 109 of the CPU/Core 102 as shown in FIG. 14. The circular buffer 901 has an associated cursor register 905 that holds an index to one of the entries of the circular buffer 901 similar to that shown in FIG. 10. The offset of each entry of the circular buffer 901 relative to the index stored in the cursor register 905 corresponds to a schedule latency (in machine cycles) relative to the current machine cycle. Each entry of the circular buffer 901 can hold a target address of a deferred conditional branch operation and an occupied bit as shown in FIG. 10. The occupied bit for the entry is set when the entry holds such a target address; otherwise, the occupied bit is cleared. The execution/retire logic 109 also includes a second buffer 907 that holds entries for determining correspondence between one or more pending taken BRANCH operations and a PICKUP operation executed by a pickup functional unit (for example, one shown as 909) as shown in FIG. 14.

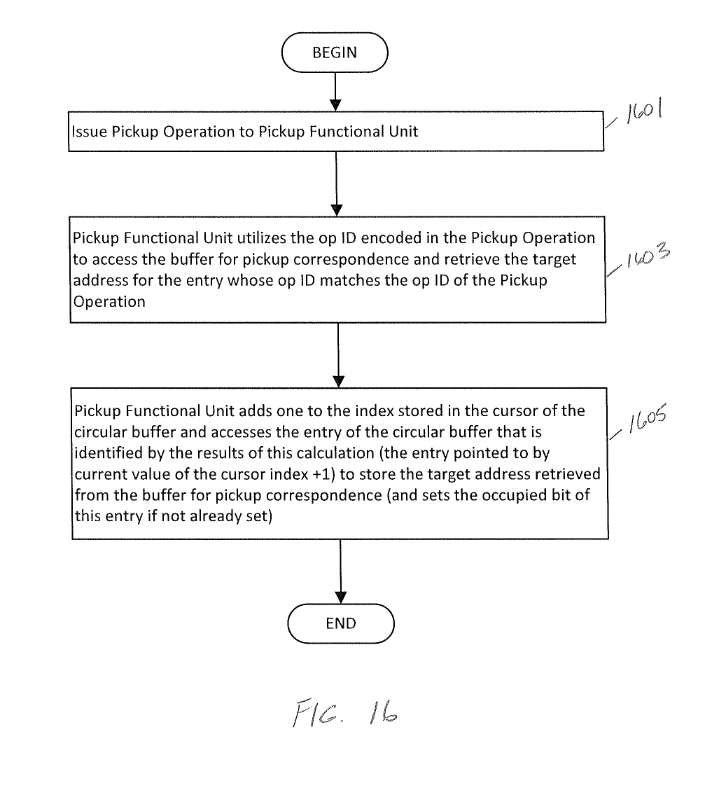

As illustrated in the flowchart of FIG. 15, each conditional BRANCH operation encoded by a wide instruction is decoded and then issued to a branch functional in block 1501 for execution in a particular phase (such as the Writer Phase). The branch functional unit evaluates the conditional predicate of the BRANCH operation in this particular phase in block 1503. It also evaluates the target address of the BRANCH operation in block 1503. The branch functional unit checks whether the conditional predicate of the BRANCH operation is true in block 1505. If so, the operations continue to blocks 1507. Otherwise, the operations continue to block 1509 where the branch functional unit can terminate the execution of the BRANCH operation without retiring the BRANCH operation.

In block 1507, the branch functional unit stores the operation identifier (op ID) encoded in the machine code of the conditional BRANCH operation and the target address of the conditional BRANCH operation in an entry of the second buffer 907.

As illustrated in the flowchart of FIG. 16, each PICKUP operation encoded by a wide instruction is decoded and then issued to a pickup functional unit in a particular phase (such as the Writer Phase) in block 1601. In block 1603, the pickup functional unit utilizes the operational identifier encoded in the PICKUP operation to access the second buffer 907 and retrieve the target address for the entry whose operational identifier matches the operational identifier of the PICKUP operation and the operations continue to block 1605. If there is no matching entry, a fault is raised and handled accordingly. In block 1605, the pickup functional unit adds one to (increments by one) the index stored in the cursor register 905 of the circular buffer 901 and accesses the entry of the circular buffer 901 that is identified by the results of this calculation (the entry pointed to by current value of the cursor index+1) to store the target address retrieved from the second buffer 907 in block 1603 (and sets the occupied bit of this entry if not already set). In effect, this overrides the previous insertion of a target addresses at this entry such that entry stores the target address for the last taken BRANCH operation.

Furthermore, the operations of FIG. 12 can be carried out by the execution/retire logic 109 of the CPU/Core 102 for each machine cycle in order to retire the last taken BRANCH operation that is set to retire in the given machine cycle and control flow transfers to the target address of the last taken BRANCH operation.

It is also contemplated that FBT can be extended to handle deferred conditional BRANCH operations with statically unknown schedule latencies. In this case, the operations of the pickup functional unit described above with respect to FIG. 16 that stores the target address retrieved from the second buffer in block 1603 (and sets the occupied bit of this entry if not already set) can be modified such that they are carried out only if the occupied bit for that entry is not already set.

It is also possible that the phases of operations processed by the CPU/Core 102 can include multiple branch operations which originate from the same wide instruction. These multiple branch operations can possibly include zero or more regular non-deferred conditional BRANCH operations and/or zero or more deferred conditional BRANCH operations. It is possible for the schedule latency of such multiple BRANCH operations to expire in the same machine cycle. In this case, the disambiguation rule can be extended to define the precedence amongst the taken BRANCH operations that originate from the same wide instruction. Such precedence can be defined in any predefined manner that is exposed to the software tool (e.g., compiler) that schedules the operation. In one embodiment, such precedence is dictated by the encoding slot order of the given wide instruction. That is, precedence amongst multiple taken BRANCH operations that originate from the same instruction and that have a schedule latency that expires in the same machine cycle is controlled according to the encoding slot order of these multiple taken BRANCH operations in the given wide instruction. In this case, the highest ranked taken BRANCH operation (the winner based on encoding slot order) can be entered (or not) into the circular buffer that controls retirement of taken BRANCH operations according to the disambiguation rule employed by the system (such as the FBT or LBT rule as described above).

The computer architectural aspects of phases of operations as described herein can approximate the flow of data in sequence of operations similar to out-of-order execution and thus provides for performance that is similar in many regards to architectures that employ out-of-order execution without the power and area costs of the out-of-order machines.

In one embodiment, the phases of operations as described herein are encoded by wide instructions contained within instruction blocks as described in U.S. patent application Ser. No. 14/290,108, filed on May 29, 2014, commonly assigned to assignee of the present application and herein incorporated by reference in its entirety. In this embodiment, each instruction block is associated with an entry address and multiple distinct instruction streams within the instruction block. The multiple distinct instruction streams include a first instruction stream and a second instruction stream. The first instruction stream has an instruction order that logically extends in a direction of increasing memory space relative to the entry address of the instruction block. The second instruction stream has an instruction order that logically extends in a direction of decreasing memory space relative to the entry address of the instruction block. The phases of operations can be assigned to the first and second instruction streams. For example, the “Reader Phase” operations and the “Compute Phase” (or “Exu Phase”) operations and the “Pick Phase” operations can be part of the first instruction stream, and the “Call Phase” operations and “Writer Phase” (or “Flow Phase”) operations can be part of the second instruction stream.

Note that ordered phases can be explicitly encoded in the wide instructions processed by the machine, and the resulting instruction stream funnels the data flow through the functional unit slots of the machine in an almost direct mapping. In doing so, the usable instruction level parallelism is essentially tripled on average, because all three phases of the most basic data flow can be done in parallel, just phase shifted by one cycle. Such instruction level parallelism can also be exploited over control flow barriers, which is beneficial when compared to traditional statically-scheduled VLIW architectures.

There have been described and illustrated herein several embodiments of a computer processor and corresponding method of operations. While particular embodiments of the invention have been described, it is not intended that the invention be limited thereto, as it is intended that the invention be as broad in scope as the art will allow and that the specification be read likewise. For example, the microarchitecture and memory organization of the CPU 101 as described herein is for illustrative purposes only. In another example, the functionality of the CPU 101 as described herein can be embodied as a processor core and multiple instances of the processor core can be fabricated as part of a single integrated circuit (possibly along with other structures). It will therefore be appreciated by those skilled in the art that yet other modifications could be made to the provided invention without deviating from its spirit and scope as claimed.

What is claimed is:

1. A computer processor comprising:
an instruction processing pipeline that processes a sequence of wide instructions, wherein each given wide instruction has an encoding that represents a plurality of different operations, wherein the plurality of different operations of the given wide instruction are logically organized into a number of phases having a predefined ordering such that at least one operation of the given wide instruction produces data that is consumed by at least one other operation of the given wide instruction.

2. A computer processor according to claim 1, wherein:
in certain circumstances where stalling is absent, the plurality of different operations of the phases of the given wide instruction are issued for execution by the instruction processing pipeline over a plurality of consecutive machine cycles.

3. A computer processor according to claim 2, wherein:
said plurality of consecutive machine cycles comprises three consecutive machine cycles.

4. A computer processor according to claim 1, wherein:
the phases of operations include at least a first phase that includes at least one operation that is a pure data source, a second phase that includes at least one operation that is both a data sink and a data source, and a third phase that includes at least one operation that is a pure data sink, wherein the least one operation of the first phase precedes the at least one operation of the second phase in the predefined order and the least one operation of the second phase precedes the at least one operation of the third phase in the predefined order.

5. A computer processor according to claim 4, wherein:
the at least one operation of the first phase includes at least one operation that defines a constant value or immediate operand value;
the at least one operation of the second phase includes a plurality of data manipulation operations selected from the group including integer operations, arithmetic operations and floating point operations; and
the at least one operation of the third phase includes at least one operation selected from the group including a branch operation and a store operation that writes operand data values to memory.

6. A computer processor according to claim 5, wherein:
the at least one operation of the second phase includes a load operation that reads operand data values from memory.

7. A computer processor according to claim 4, wherein:
the at least one operation of the first phase is issued for execution before issuance of the at least one operation of the second phase; and
the least one operation of the second phase is issued for execution before issuance of the at least one operation of the third phase.

8. A computer processor according to claim 7, wherein:
in certain circumstances where stalling is absent, the plurality of different operations of the phases of the given wide instruction are issued for execution by the instruction processing pipeline over three consecutive machine cycles, wherein the at least one operation of the first phase is issued for execution in the first machine cycle of the three consecutive machine cycles, wherein the least one operation of the second phase is issued for execution in the second machine cycle of the three consecutive machine cycles, and wherein the at least one operation of the third phase is issued for execution in the third machine cycle of the three consecutive machine cycles.

9. A computer processor according to claim 4, wherein:
said phases of operations include a fourth phase that includes at least one CALL operation that transfers control to a target code segment.

10. A computer processor according to claim 9, wherein:
at least one operation of the fourth phase follows the at least one operation of the second phase in the predefined order; and
the at least one operation of the fourth phase precedes the at least one operation of the third phase in the predefined order.

11. A computer processor according to claim 9, wherein:
the at least one operation of the third phase includes at least one RETURN operation to a Caller code segment.

12. A computer processor according to claim 9, wherein:
the fourth phase includes a plurality of conditional CALL operations whose precedence in control flow during execution is dictated dynamically by evaluation of a predefined rule.

13. A computer processor according to claim 12, wherein:
the predefined rule is based on the order of the plurality of conditional CALL operations in the wide instruction.

14. A computer processor according to claim 4, wherein:
said phases of operations include a fifth phase that includes at least one operation that selects one of two source operand values based on a conditional predicate, where at least one operation of the fifth phase follows the least one operation of the second phase in the predefined order and wherein the at least one operation of the fourth phase precedes the at least one operation of the third phase in the predefined order.

15. A computer processor according to claim 1, wherein:
the wide instruction includes a plurality of encoding slots that contain the different operations of the phases of the wide instruction; and
the instruction processing pipeline includes a plurality of functional unit slots that correspond to the plurality of encodings slots and that include functional units that are configurable to execute the phases of operations that are contained in the corresponding encodings slots.

16. A computer processor according to claim 15, wherein:
the plurality of functional unit slots includes at least one functional unit slot with a plurality of functional units that share a set of input data paths.

17. A computer processor according to claim 15, wherein:
the plurality of functional unit slots includes at least one functional unit slot with a plurality of functional units that share a set of dedicated result registers.

18. A computer processor according to claim 15, wherein:
the plurality of functional unit slots includes at least one functional unit slot with at least one ganged functional unit having at least one input data path leading from a neighboring functional unit slot.

19. A computer processor according to claim 18, wherein:
the at least one input data path leading from the neighboring functional unit slot is used to carry source operand data values to the ganged functional unit during the processing of a special operation encoded as part of a wide instruction.

20. A computer processor according to claim 18, wherein:
the at least one input data path leading from the neighboring functional unit slot is used to carry conditional codes or other state information produced by the neighboring functional unit slot to the ganged functional unit during the processing of a special operation encoded as part of a wide instruction.

21. A computer processor according to claim 1, wherein:
at least one operation of the given wide instruction includes multiple actions as part of its overall effect and these multiple actions occur in different phases of the given wide instruction.

22. A computer processor according to claim 1, wherein:
at least one operation of the given wide instruction represents a deferred conditional branch operation for processing within the phases of the given wide instruction.

23. A computer processor according to claim 22, wherein:
the deferred conditional branch operation has a schedule latency controlled by statically-assigned parameter data included in the encoding of the deferred operation.

24. A computer processor according to claim 23, wherein:
the statically-assigned parameter data represents a number of machine cycles between issue of the deferred conditional branch operation and retiring the deferred conditional branch operation under the assumption that a conditional predicate for the deferred conditional branch operation is evaluated as true.

25. A computer processor according to claim 23, wherein:
the statically-assigned parameter data represents an operational identifier that is used by a corresponding pickup operation whose execution dictates the machine cycle in which the result data produced by execution of the deferred operation is retired.

26. A computer processor according to claim 22, wherein:
the computer processor includes logic that is configured to follow a disambiguation rule that selects one deferred conditional branch operation from a plurality of deferred conditional branch operations that are set to retire in the same machine cycle and retires the selected one deferred branch operation in that machine cycle.

27. A computer processor according to claim 26, wherein:
the logic includes a circular buffer and associated cursor register, wherein entries of the circular buffer correspond to different schedule latencies relative to the index stored in the cursor register.

28. A computer processor according to claim 27, further comprising:
a plurality of branch functional units that interface to the logic and cooperate to follow the disambiguation rule.

29. A computer processor according to claim 27, wherein:
the logic further comprises a second buffer for storing entries used in determining correspondence between a deferred conditional branch operation and a pickup operation that share a common operational identifier as part of the machine code of their respective operations.

30. A computer processor according to claim 29, further comprising:
at least one pickup functional unit that interfaces to the logic to follow the disambiguation rule.

31. A computer processor according to claim 26, wherein:
the disambiguation rule is selected from the group consisting of a first taken branch wins rule and a last taken branch wins rule.

32. A computer processor according to claim 26, wherein:
the disambiguation rule further involves identifying precedence for one deferred conditional branch operation from a plurality of deferred conditional branch operations that originate from the same wide instruction in accordance with slot ordering of the deferred conditional branch operations that originate from the same wide instruction.
